(19) United States
(12) Patent Application Publication
(10) Pub. No.: US 2013/0142136 A1
(43) Pub. Date: Jun. 6, 2013

(54) METHODS AND APPARATUS FOR ADAPTIVE WIRELESS BACKHAUL AND NETWORKS

(71) Applicant: SAMSUNG ELECTRONICS CO., LTD., Suwon-si (KR)

(72) Inventors: Zhouyue Pi, Allen, TX (US); Farooq Khan, Allen, TX (US); Ying Li, Richardson, TX (US); Shadi Abu-Surra, Richardson, TX (US); Sridhar Rajagopal, Plano, TX (US)

(73) Assignee: SAMSUNG ELECTRONICS CO., LTD., Suwon-si (KR)

(21) Appl. No.: 13/652,303

(22) Filed: Oct. 15, 2012

Related U.S. Application Data
(60) Provisional application No. 61/550,229, filed on Oct. 21, 2011.
(60) Provisional application No. 61/577,488, filed on Dec. 19, 2011.

(51) Int. Cl. H04W 28/02

(52) U.S. Cl. CPC H04W 28/0289
USPC 370/329

(57) ABSTRACT

A communication network includes a base station configured to wirelessly communicate first communication traffic with a first network entity using a first beam, and communicate second communication traffic with a second network entity using a second beam. Each of the first and second communication traffic includes at least one of backhaul traffic, wireless access traffic, and traffic for coordination in-between network entities.

### CROSS-REFERENCE TO RELATED APPLICATION(S) AND CLAIM OF PRIORITY

The present application is related to U.S. Provisional Patent Application No. 61/550,229, filed Oct. 21, 2011, entitled “METHODS AND APPARATUS FOR ADAPTIVE WIRELESS BACKHAUL AND NETWORKS” and U.S. Provisional Patent Application No. 61/577,488, filed Dec. 19, 2011, entitled “METHODS AND APPARATUS TO SUPPORT IN-BAND WIRELESS BACKHAUL IN MILLIMETER WAVE WIDEBAND COMMUNICATIONS”. Provisional Patent Application Nos. 61/550,229 and 61/577,488 are assigned to the assignee of the present application and are hereby incorporated by reference into the present application as if fully set forth herein. The present application hereby claims priority under 35 U.S.C. §119(e) to U.S. Provisional Patent Application Nos. 61/550,229 and 61/577,488.

### TECHNICAL FIELD

The present application relates generally to wireless communications, and more particularly, to a method apparatus for adaptive wireless backhaul.

### BACKGROUND

Current 4G systems including LTE and Mobile WiMAX use advanced technologies such as OFDM (Orthogonal Frequency Division Multiplexing), MIMO (Multiple Input Multiple Output), multi-user diversity, link adaptation, etc, in order to achieve spectral efficiencies which are close to theoretical limits in terms of bps/Hz/cell. Continuous improvements in air-interface performance are being considered by introducing new techniques such as carrier aggregation, higher order MIMO, coordinated Multipoint (COMP) transmission and relays, and the like. However, it is generally agreed that any further improvements in spectral efficiency may only be marginal even in best case conditions.

In existing wireless networks, base stations are typically connected to the core network and in some cases to other networks, such as the Internet via wired or wireless backhaul connections. As base station deployment density continues to increase, wireless backhaul is increasingly becoming a viable option. In a wireless network including wireless backhaul links, such as microwave relay stations, hubs may be used that aggregate backhaul traffic from multiple base stations.

When spectral efficiency in terms of bps/Hz/cell cannot be improved significantly, another possibility to increase capacity is to deploy many smaller cells. However, the number of small cells that can be deployed in a geographic area can be limited due to costs involved for acquiring the new site, installing the equipment and provisioning backhaul. In theory, to achieve 1,000-fold increase in capacity, the number of cells also needs to be increased by the same factor. Another drawback of very small cells is frequent handoffs which increase network signaling overhead and latency. Small cells are need for future wireless networks, but they themselves alone are not expected to meet the capacity required to accommodate orders of magnitude increase in mobile data traffic demand in a cost effective manner.

### SUMMARY

According to certain embodiments, a communication method includes wirelessly communicating first communication traffic with a first network entity using a first beam, and wirelessly communicating second communication traffic with a second network entity using a second beam. Each of the first and second communication traffic includes at least one of backhaul traffic, wireless access traffic, and traffic for coordination in-between network entities.

According to certain embodiments, a communication network includes a first network entity. The first network entity is configured to wirelessly communicate first communication traffic with a second network entity using at least one of a first beam. The first network entity is also configured to wirelessly communicate second communication traffic with a third network entity using at least one of a second beam. Each of the first and second communication traffic includes at least one of backhaul traffic, wireless access traffic, and traffic for coordination in-between network entities.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless backhaul communication system according to one embodiment of the present disclosure;

FIG. 2 illustrates another example wireless backhaul communication system according to one embodiment of tie present disclosure;

FIG. 3 illustrates another example wireless backhaul communication system according to one embodiment of the present disclosure;

FIG. 4 illustrates another example wireless backhaul communication system according to one embodiment of the present disclosure;

FIG. 5 illustrates another example wireless backhaul communication system according to one embodiment of the present disclosure;

FIG. 6 illustrates an example wireless backhaul communication system according to one embodiment of the present disclosure;

FIG. 7 illustrates an example wireless backhaul communication system according to one embodiment of the present disclosure;

FIG. 8 illustrates another example communication network showing multiple links operating simultaneously via different polarization according to one embodiment of the present disclosure;

FIG. 9 illustrates example LHCP and RHCP using cross-polarized antennas according to one embodiment of the present disclosure;

FIGS. 10 and 11 illustrate example electric fields relative to one another according to one embodiment of the present disclosure;

FIG. 12 illustrates another example communication network showing multiple links operating simultaneously via different polarization according to one embodiment of the present disclosure;

FIG. 13 illustrates an example wireless backhaul communication system according to one embodiment of the present disclosure;

FIG. 14 illustrates an example transient access point (TAP) according to one embodiment of the present disclosure;

FIG. 15 illustrates an example wireless backhaul communication system according to one embodiment of the present disclosure;

FIG. 16 illustrates an example method of turning a TAP on or off according to one embodiment of the present disclosure;

FIG. 17 illustrates an example method of turning a TAP on or off according to one embodiment of the present disclosure;

FIG. 18 illustrates an example state transition diagram including various states in which the TAP may exist during its operation according to one embodiment of the present disclosure;

FIG. 19 illustrates an example communication procedure that may be performed by the TAP according to one embodiment of the present disclosure;

FIGS. 20 and 21 illustrate alternative example initialization procedures that may be performed by the TAP according to one embodiment of the present disclosure;

FIGS. 22 through 24 illustrate several example idle states the TAP may function in according to one embodiment of the present disclosure;

FIG. 25 illustrates an example wireless communication network according to one embodiment of the present disclosure;

FIG. 26 illustrates an example beam structure according to one embodiment of the present disclosure;

FIG. 27 illustrates another example wireless backhaul communication system according to one embodiment of the present disclosure;

FIG. 28 illustrates another example wireless backhaul communication system according to one embodiment of the present disclosure;

FIG. 29 illustrates an example wireless backhaul communication system according to one embodiment of the present disclosure;

FIG. 30 illustrates an example wireless backhaul communication system and a frame structure according to one embodiment of the present disclosure;

FIG. 31 illustrates an example wireless backhaul communication system and a frame structure showing an example of multiplexing wireless access and wireless in-band backhaul in the spatial domain, as well as in the frequency subcarrier domain, according to one embodiment of the present disclosure;

FIG. 32 illustrates an example wireless backhaul communication system showing different arrays facing different directions used for multiplexing wireless access and wireless in-band backhaul according to one embodiment of the present disclosure;

FIG. 33 illustrates an example wireless backhaul communication system and an associated frame structure showing an example of multi-hop wireless in-band backhaul by using arrays facing different directions from the arrays for wireless access according to one embodiment of the present disclosure;

FIG. 34 illustrates an example wireless backhaul communication system and an associated call flow diagram showing a BS that can assign certain antennas, subarrays, or arrays in one or more cells to function like an MS, while providing backhaul communication, according to one embodiment of the present disclosure;

FIG. 35 illustrates an example wireless network, which performs the various embodiments above, according to the principles of the present disclosure;

FIG. 36A is a high-level diagram of an orthogonal frequency division multiple access (OFDMA) transmit path;

FIG. 36B is a high-level diagram of an orthogonal frequency division multiple access (OFDMA) receive path;

FIG. 37A illustrates a transmit path for multiple input multiple output (MIMO) baseband processing and analog beam forming with a large number of antennas according to embodiments of this disclosure;

FIG. 37B illustrates another transmit path for MIMO baseband processing and analog beam forming with a large number of antennas according to embodiments of this disclosure;

FIG. 37C illustrates a receive path for MIMO baseband processing and analog beam forming with a large number of antennas according to embodiments of this disclosure; and

FIG. 37D illustrates another receive path for MIMO baseband processing and analog beam forming with a large number of antennas according to embodiments of this disclosure.

### DETAILED DESCRIPTION

As previously described, wireless networks may be implemented with wireless backhaul links. Nevertheless, the topology of these networks tends to be fixed, and therefore cannot adapt to ever changing channel conditions. For example, a base station may be coupled to a hub via a fixed microwave backhaul link that typically uses high gain antennas (e.g., dish antennas). The base station, however, does not have the flexibility to connect to the network via a different route when the microwave backhaul link is congested or fails.

For the purpose of illustration, we will use extensively the terms “antenna array” and “beamforming” in the description of this invention. However, the embodiments of this invention are certainly applicable for other kinds of antenna designs and other kind of multi-antenna technologies such as spatial multiplexing, MIMO precoding, single-user MIMO, multi-user MIMO, spatial division multiple access (SDMA), etc.

Throughout the disclosure, the beams (including TX beams and RX beams) can have various beam widths or various shapes, including regular or irregular shapes, not limited by those in the figures.

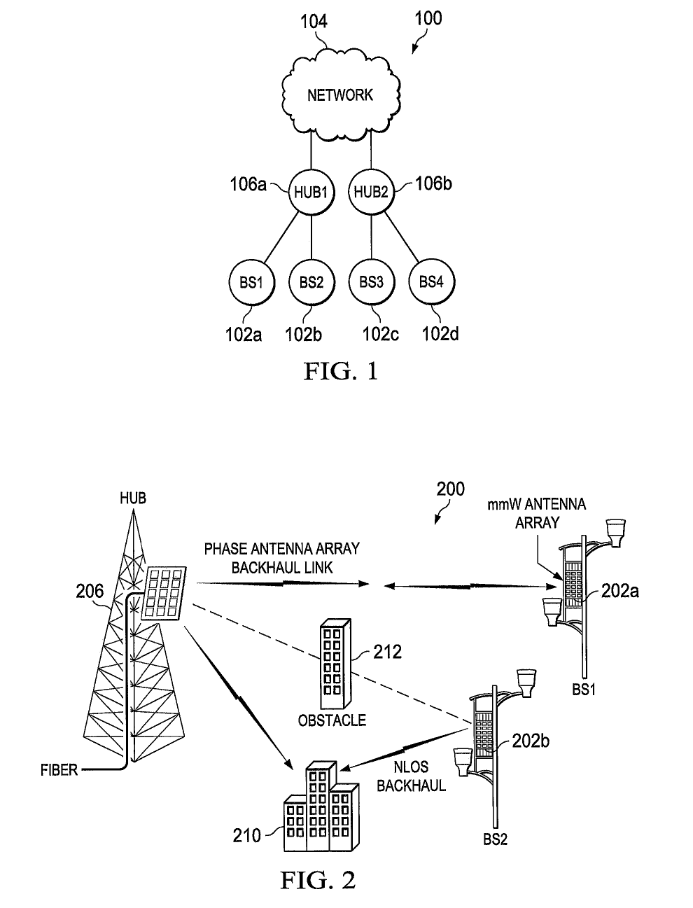

FIG. 1 illustrates an example wireless backhaul communication system 100 according to the teachings of the present disclosure. The embodiment of the wireless backhaul communication system 100 shown in FIG. 1 is for illustration only. Other embodiments could be used without departing from the scope of this disclosure.

Wireless backhaul communication system 100 includes one or more base stations (BSs) 102 that communicate with a core network 104 through a plurality of hubs 106. As will be described in detail below, the hubs 106 and/or BSs 102 include adaptive antenna arrays for generating beams directed at the BSs with which they communicate. Further, in certain embodiments, the beams are dynamically adjusted according to various factors associated with communication traffic, such as prevailing channel conditions, failure of one or more redundant communication paths, or quality of service (QoS) requirements.

Adaptive antenna arrays that form spatial beams can be deployed in both the hub and the base station. In most cases, these beams improve a signal quality along a certain spatial direction over the signal quality that can be otherwise achieved using omni-directional antennas, such as single dipole antennas. The improvement provided by these antenna arrays may be referred to as beamforming gain. In addition, both the transmitter and/or the receiver can form the spatial beams electronically, and thus can adjust or change the direction of the beams adaptively. Moreover, the beamforming gain in both the transmitter and receiver can allow its associated wireless communication link to function in non-line-of-sight (NLOS) conditions.

FIG. 2 illustrates another example wireless backhaul communication system 200 according to the teachings of the present disclosure. The embodiment of the wireless backhaul communication system 200 shown in FIG. 2 is for illustration only. Other embodiments could be used without departing from the scope of this disclosure.

Wireless backhaul communication system 200 includes one or more base stations (BSs) 202a and 202b that communicate with a hub 206. As shown, BS 202a communicates with hub 206 using a line of sight (LOS) link. BS 202b, on the other hand establishes a non line of sight (NLOS) link via a reflection path in which the radio-frequency signal is reflected from a building 210 because its direct path to the hub 206 is blocked by building 212. Accordingly, certain embodiments of a wireless backhaul network incorporating adaptive antenna arrays present opportunities to construct innovative network topologies with enhanced flexibility, and robustness relative to conventional network topologies.

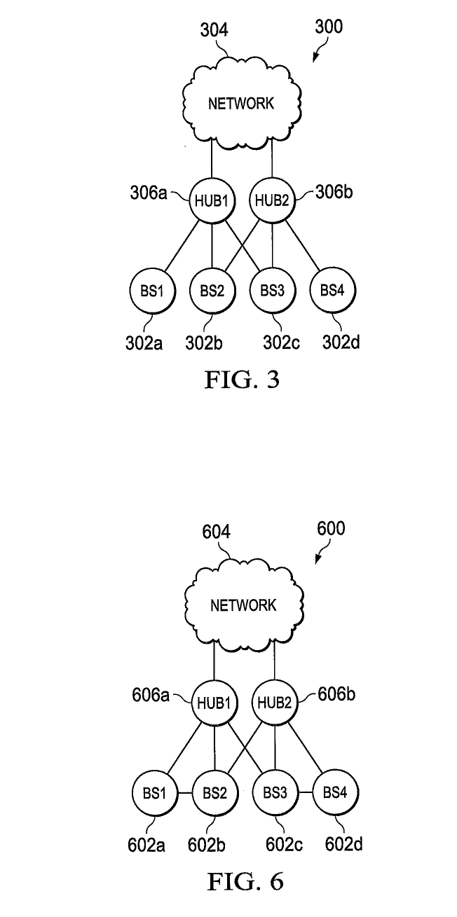

FIG. 3 illustrates another example wireless backhaul communication system 300 according to the teachings of the present disclosure. The embodiment of the wireless backhaul communication system 300 shown in FIG. 3 is for illustration only. Other embodiments could be used without departing from the scope of this disclosure.

Wireless backhaul communication system 300 includes one or more base stations CBEs) 302 that communicate with a core network 304 through a plurality of hubs 306. As shown, BS 302b communicates with a first hub 306a using a first beam, and communicates with a second hub 306b using a second beam. In certain embodiments of a communication network such as a MIMO or CDMA network incorporating space, time, frequency, and/or code diversity, the base station 302b communicates with a first hub 302a using a first time slot or frequency while the communication between the base station 302b and the second hub 306b can occur in a second time slot or frequency.

In certain embodiments, the first time slot is the same as the second time slot. In certain embodiments, the first time slot is not the same as the second time slot. In certain embodiments, the first frequency is the same as the second frequency. In certain embodiments, the first frequency is not the same as the second frequency. For example, BS2 302b can communicate with Hub1 306a in a first slot using a first beam, and communicate with Hub2 306b in a second slot using a second beam. Additionally, BS2 202b can communicate with Hub1 306a in a first sub-carrier of a MIMO stream, and communicate with Hub2 306b in a second sub-carrier of a MIMO stream. Communication using independent beams can be provided by deploying antenna arrays at both the hubs 306 and base stations 302. For example, in the first slot, Hub1 306a can form a transmitter beam towards BS2 302b. At the same time, BS2 302b forms a receiver beam towards Hub1 306a. As a result of beamforming by both the transmitter and receiver, the signal quality is enhanced for the link between Hub1 306a and BS2 302b, which further results in increased data rate and/or reliability. In certain situations however, BS2 302b communicates with Hub2 306b instead of or in addition to the communication with Hub1 306a when certain events occur, such as disruption of the communication link between Hub1 306a and BS2 302b, overloading of the link between Hub1 306a and BS2 302b, or congestion of the link between Hub1 306a and the backbone network. In events such as these, Hub2 306b form a transmitter beam directed towards BS2 302b. At the same time, BS2 302b form a receiver beam directed towards Hub2 306b. As a result of this re-direction, the signal quality increases for the link between Hub2 306b and BS2 302b, thus further enhancing the data rate and reliability of the link.

In certain embodiments, one or more of the hubs 106 transmit an indication of its loading level, congestion level, buffer size, or packet delay, via a wireless backhaul link, to a base station. BS2 302a then decides whether to transmit its packet to Hub1 306a or Hub2 306b based on the relative condition of these two hubs. Additionally, BS2 302b decides to route a portion of the packets to Hub1 306a and another portion of the packets to Hub2 306b to distribute the load between the two hubs.

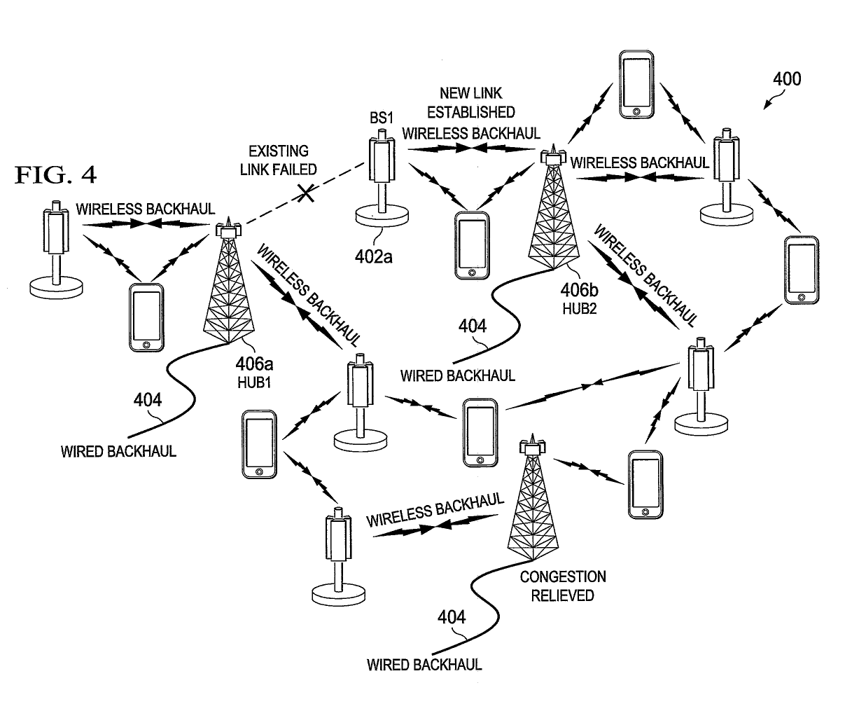

FIG. 4 illustrates another example wireless backhaul communication system 400 according to the teachings of the present disclosure. The embodiment of the wireless backhaul communication system 400 shown in FIG. 4 is for illustration only. Other embodiments could be used without departing from the scope of this disclosure.

Wireless backhaul communication system 400 includes multiple BSs 402 that communicate with one or more wired backhaul links 404 through a plurality of hubs 406. As shown, the communication link between Hub 406a and BS 402a is either congested or disrupted. In this event, BS 402a adapts the beamforming of its antenna array to establish communication with Hub 406b, thus maintaining backhaul communication with the network. For example, BS 402a monitors the channel quality for the link from Hub 406a to BS 402a (e.g., by estimating the signal interference to noise ratio (SINR) based on reference signal transmitted by Hub 406a). BS 402a also monitors the channel quality for the link from Hub 406b to BS 402a. BS 402a then decides to transmit at least one packet to or receive at least one packet from Hub 406b if the channel quality of the link between Hub 406b and BS 402a becomes better than the channel quality of the link between Hub 406a and BS 402a by a certain threshold value for a certain period of time.

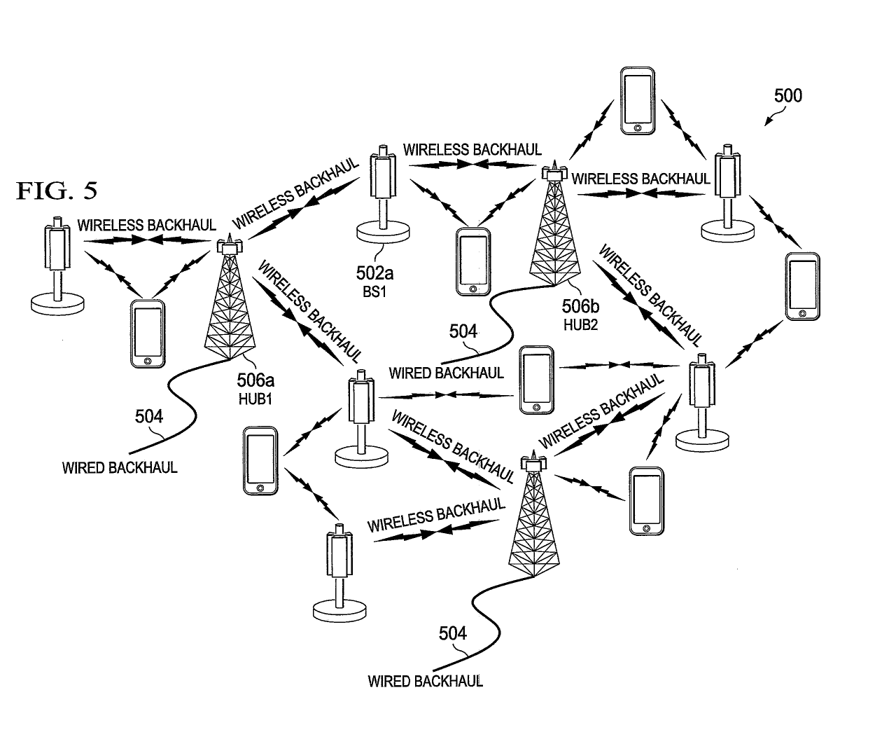

FIG. 5 illustrates another example wireless backhaul communication system 500 according to the teachings of the present disclosure. The embodiment of the wireless backhaul communication system 500 shown in FIG. 5 is for illustration only. Other embodiments could be used without departing from the scope of this disclosure.

Wireless backhaul communication system 500 includes multiple BSs 502 that communicate with one or more wired backhaul links 504 through a plurality of hubs 506. A base station can communicate with two hubs via wireless links at the same time. Alternatively, a base station can maintain the links with two hubs at the same time while communicating with one hub at a time.

As shown, the BSs can simultaneously communicate over multiple links. For example, BS 502a simultaneously communicates with hubs 506a and 506b via wireless links, or alternatively, BS 502a simultaneously maintain active links with the two hubs 506a and 506b while communicating traffic through only one of the hubs. This is achieved by BS 502a forming a first beam to transmit to or receive from Hub 506a and forming a second beam to transmit to or receive from Hub 506b. Likewise, Hub 506a can form a third beam to receive from or transmit to BS 502a while Hub 506b can form a fourth beam to receive from or transmit to BS 502a. Note that, in certain embodiments, the hubs also form other beams to transmit to or receive from other base stations, or hubs, or mobile stations. The beams are preferably formed by one or more antenna arrays. For example, BS 502a uses a first antenna array to form the first beam and a second antenna array to form the second beam. Alternatively, BS 502a uses the first antenna array to form both the first beam and the second beam.

FIG. 6 illustrates an example wireless backhaul communication system 600 according to the teachings of the present disclosure. The embodiment of the wireless backhaul communication system 600 shown in FIG. 6 is for illustration only. Other embodiments could be used without departing from the scope of this disclosure.

Wireless backhaul communication system 600 includes one or more base stations (BSs) 602 that communicate with a core network 604 through a plurality of hubs 606. BS1 602a and BS2 602b can establish a communication link in between by forming beams using adaptive antenna arrays. This link between BS1 602a and BS2 602b is part of the backhaul for either BS1 602a or BS2 602b. For example, BS1 602a transmits a first packet to Hub1 606a via the link between BS1 602a and Hub1 606a. BS1 602a transmits a second packet to BS2 602b via the link between BS1 602a and BS2 602b. BS2 602b then forwards the said second packet to Hub1 606a via the link between BS2 602b and Hub1 606a. This increases the capacity and robustness of the backhaul available for BS1 602a. Likewise, BS2 602b can transmit a third packet to Hub1 606a via the link between BS2 602b and Hub1 606a. BS2 606b can transmit a fourth packet to BS1 602a via the link between BS1 602a and BS2 602b. BS1 602a then forward the said fourth packet to Hub1 606a via the link between bSl 602a and Hub1 606a. This can increase the capacity and robustness of the backhaul available for BS2 602b. A route with multiple hops via multiple BSs can be implemented in some embodiments.

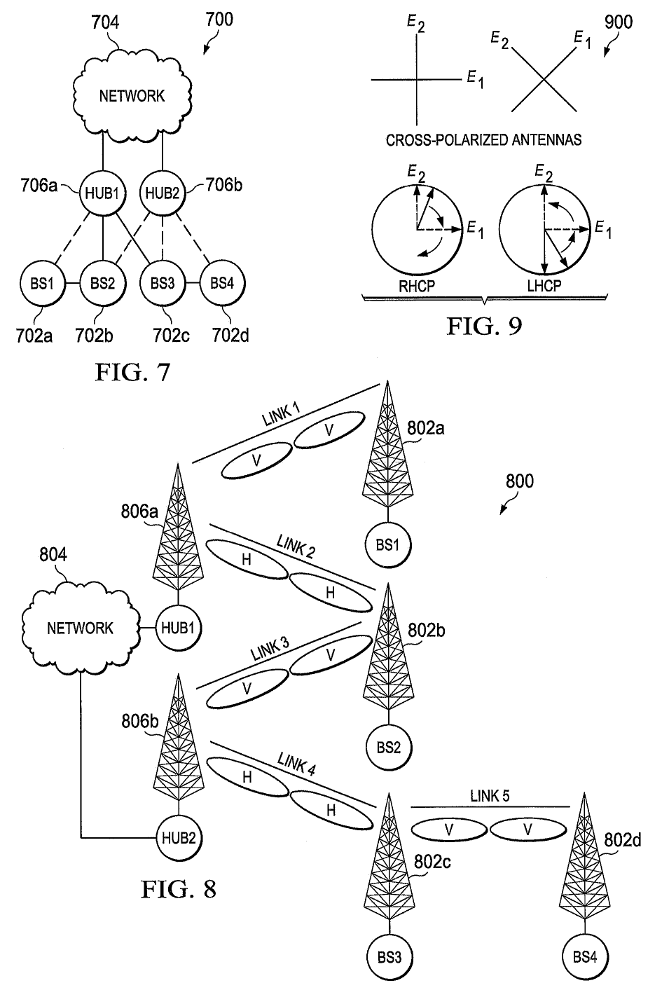

FIG. 7 illustrates an example wireless backhaul communication system 700 according to the teachings of the present disclosure. The embodiment of the wireless backhaul communication system 700 shown in FIG. 7 is for illustration only. Other embodiments could be used without departing from the scope of this disclosure.

Wireless backhaul communication system 700 includes one or more base stations (BSs) 702 that communicate with a core network 704 through a plurality of hubs 706. In certain occasions that the link between BS1 702a and Hub1 706a is congested or disrupted. In this case, BS1 702a can still connect to the network via the link between BS1 702a and BS2 702b, and the link between BS2 702b and Hub1 706a.

Additionally, if the link between Hub2 706b and the network is congested or disrupted, then the throughput of the link between BS2 702b and Hub2 706b, the link between BS3 702c and Hub2 706b, and the link between BS4 702d and Hub2 706b will also be congested or disrupted. In this case, BS2 702b can connect to the network via the link between BS2 702b and Hub1 706a, BS3 702c can connect to the network via the link between BS3 702c and Hub1 706a, BS4 702d can connect to the network via the link between BS3 702c and BS4 702d, and the link between BS3 702c and Hub1 706a. As a result, despite that the link between BS1 702a and Hub1 706a, and all links via Hub2 706b, are congested or disrupted, BS1 702a, BS2 702b, BS3 702c, and BS4 702d can still be connected to the network.

FIG. 8 illustrates another example communication network 800 showing multiple links operating simultaneously via different polarization according to one embodiment of the present disclosure. The embodiment of the communication network 800 shown in FIG. 8 is for illustration only. Other embodiments could be used without departing from the scope of this disclosure.

Network 800 includes multiple BSs 802 that communicate with a core network 804 through one or more hubs 806. Specifically, Hub1 806a communicates with BS1 802a and BS2 802b on orthogonal polarization beams with vertical polarized beam used for communications between Hub1 806a and BS1 802a, thus forming Link1 while horizontally polarized beam is used for communication between Hub1 806a and BS2 802b, thus forming Link2. This arrangement reduces interference between Link1 and Link2 communication as the two links use orthogonal polarized antenna arrays/beams.

Similarly, Hub2 806b communicates with BS2 802b and BS3 802c on orthogonal polarization beams with vertical polarized beam used for communications between Hub2 806b and BS2 802b, thus forming Link3 while a horizontally polarized beam is used for communication between Hub2 806b and BS3 802c, thus forming Link4. This arrangement reduces interference between Link2 and Link3 communication as the two links use orthogonal polarized antenna arrays/beams.

The polarization of an antenna is the orientation of the electric field (E-plane) of the radio wave with respect to the Earth's surface and is determined by the physical structure of the antenna and by its orientation. Thus, a simple straight wire antenna will have one polarization when mounted vertically, and a different polarization when mounted horizontally.

In the most general case, polarization is elliptical, meaning that the polarization of the radio waves varies over time. Two special cases are linear polarization (the ellipse collapses into a line) and circular polarization (in which the two axes of the ellipse are equal). In linear polarization the antenna compels the electric field of the emitted radio wave to a particular orientation. Depending on the orientation of the antenna mounting, the usual linear cases are horizontal and vertical polarization. In circular polarization, the antenna continuously varies the electric field of the radio wave through all possible values of its orientation with regard to the Earth's surface. Circular polarizations, like elliptical ones, are classified as Right Hand Circularly Polarized (RHCP) and Left Hand Circularly Polarized (LHCP).

Cross polarization (sometimes referred to as X-pol) is the polarization orthogonal to the polarization being discussed. For instance, if the fields from an antenna are meant to be horizontally polarized, the cross-polarization in this case is vertical polarization. If the polarization is Right Hand Circularly Polarized (RHCP), the cross-polarization is Left Hand Circularly Polarized (LHCP).

An elliptical polarization is the polarization of electromagnetic radiation such that the tip of the electric field vector describes an ellipse in any fixed plane intersecting, and normal to, the direction of propagation. An elliptically polarized wave may be resolved into two linearly polarized waves in phase quadrature, with their polarization planes at right angles to each other. Since the electric field can rotate clockwise or counterclockwise as it propagates, we can differentiate Right Hand Elliptical Polarization (RHEP) and Left Hand Elliptical Polarization (LHEP). Other forms of polarization, such as circular and linear polarization, can be considered to be special cases of elliptical polarization.

In the case of a circularly polarized wave, the tip of the electric field vector, at a given point in space, describes a circle as time progresses. Similar to elliptical polarization, electric field can rotate clockwise or counterclockwise as it propagates thus exhibiting either Right Hand Circular Polarization (RHCP) or Left Hand Circular Polarization (LHCP). In this invention, polarization is defined from the point of view of the source. Therefore, left or right handedness is determined by pointing one's left or right thumb away from the source, in the same direction that the wave is propagating, and matching the curling of one's fingers to the direction of the temporal rotation of the field at a given point in space.

FIG. 9 illustrates example LHCP and RHCP using cross-polarized antennas according to one embodiment of the present disclosure. The embodiment of the LHCP and RHCP 900 shown in FIG. 9 is for illustration only. Other embodiments could be used without departing from the scope of this disclosure.

A circularly polarized wave can be generate using two antennas such as dipole antennas in which the first antenna is placed in Vertical position and the second antenna is placed in Horizontal position. The angle between these two antennas should be maintained at 90°. Therefore, it is also possible to place these antennas on “X” arrangement in which the first antenna has an angle of 45° and the second antenna has an angle 135° with respect to Earth. The electric fields may be represented from the two cross-polarized polarized antennas as electric fields E₁ and E₂.

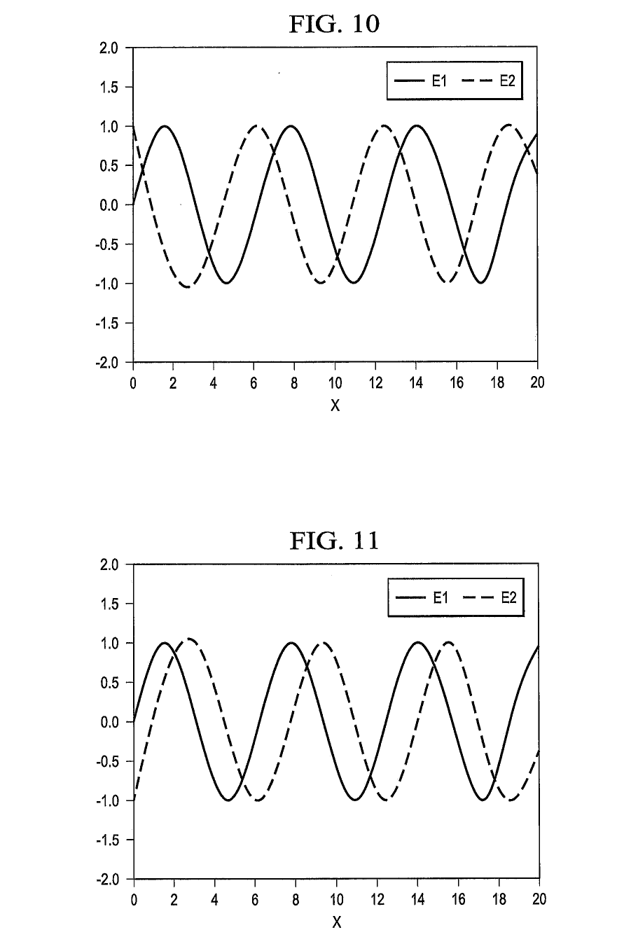

FIGS. 10 and 11 illustrate example electric fields relative to one another according to one embodiment of the present disclosure. The embodiment of the electric fields shown in FIGS. 10 and 11 are for illustration only. Other embodiments could be used without departing from the scope of this disclosure.

As shown in FIG. 10, a RHCP wave can be generated when the field E₁ is leading the field E₂ by 90° degrees (e.g., π/2 radians). As shown in FIG. 11, a LHCP wave can be generated when the field E₂ is leading the field E₁ by 90° degrees (e.g., π/2 radians).

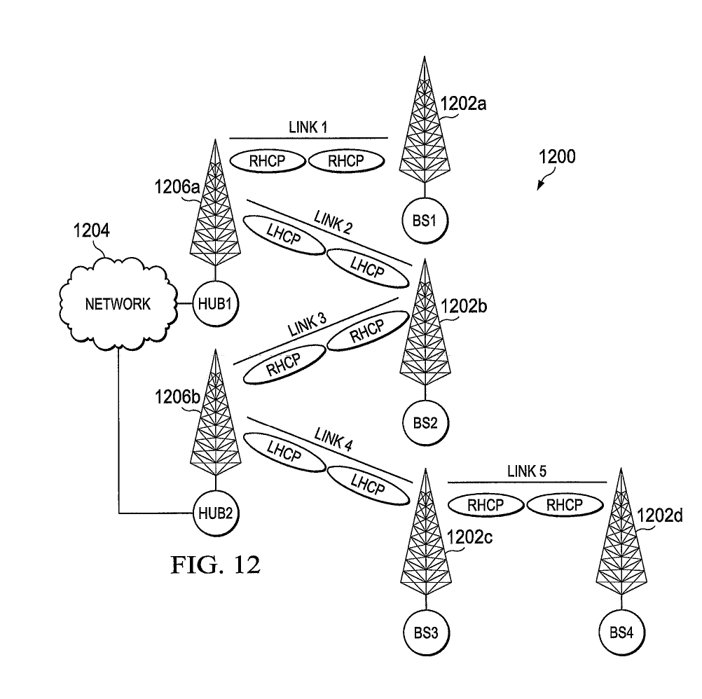

FIG. 12 illustrates another example communication network 1200 showing multiple links operating simultaneously via different polarization according to one embodiment of the present disclosure. The embodiment of the communication network 1200 shown in FIG. 12 is for illustration only. Other embodiments could be used without departing from the scope of this disclosure.

Network 1200 includes multiple BSs 1202 that communicate with a core network 1204 through one or more hubs 1206. Specifically, Hub1 1206a communicates with BS1 1202a and BS2 1202b on orthogonal polarization beams with RHCP beam used for communications between Hub1 1206a and BS1 1202a, thus forming Link1 while LHCP beam is used for communication between Hub1 1206a and BS2 1202b, thus forming Link2. Similarly, Hub2 1206b communicates with BS2 1202b and BS3 1202c using circular polarization beams with a RHCP beam used for communications between Hub2 1206b and BS2 1202b, thus forming Link3 while a LHCP beam is used for communication between Hub2 1206b and BS3 1202c, thus forming Link4. This arrangement can reduce interference between Link2 and Link3 communication as the two links use opposite circular polarization in some embodiments.

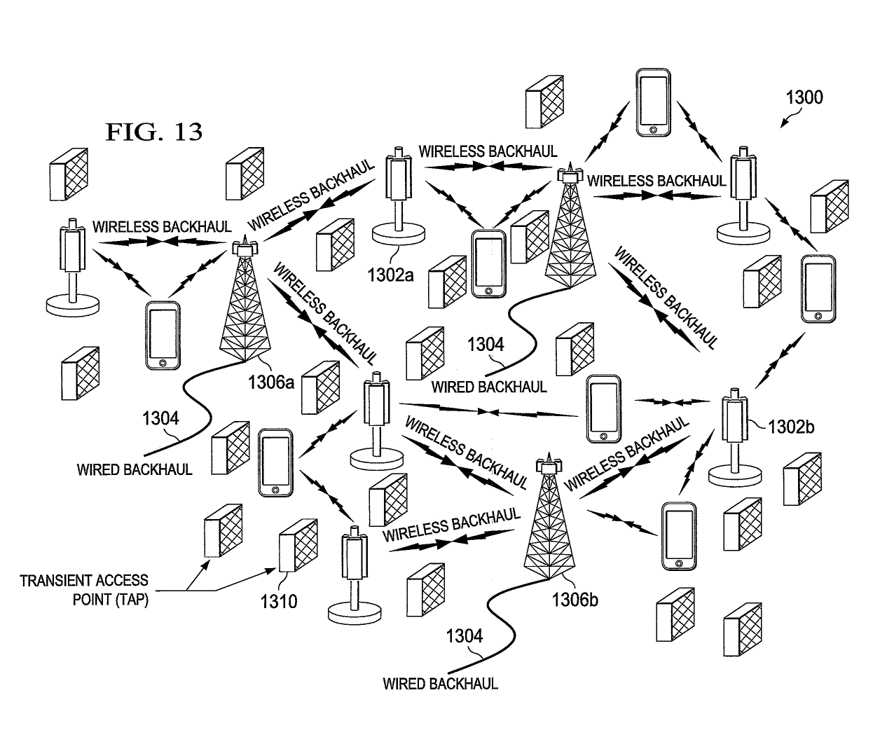

FIG. 13 illustrates an example wireless backhaul communication system 1300 according to the teachings of the present disclosure. The embodiment of the wireless backhaul communication system 1300 shown in FIG. 13 is for illustration only. Other embodiments could be used without departing from the scope of this disclosure.

Wireless backhaul communication system 1300 includes multiple BSs 1302 that communicate with one or more wired backhaul links 1304 through a plurality of hubs 1306. As will be described in detail below, the hubs 1306 and/or BSs 1302 include adaptive antenna arrays for generating beams directed at the BSs with which they communicate. Also included are multiple transient access points (TAPS) 1310 that can be deployed to further increase the deployment density of the wireless network. In general, a TAP 1310 includes an access point or base station that is only turned on for a small portion of the time. In other words, the duty cycle of the TAP is adjustable. In addition, a TAP 1310 does not require any wired backhaul link to be connected to the core network. Preferably, a TAP is also self-sufficient on its energy use.

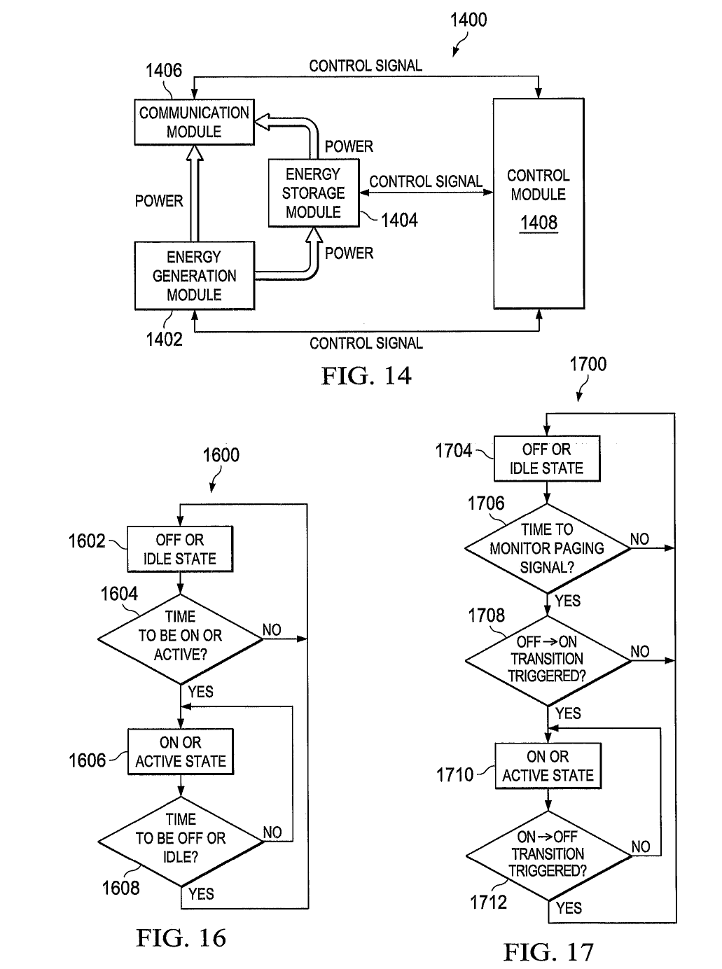

FIG. 14 illustrates an example transient access point (TAP) 1400 according to one embodiment of the present disclosure. The embodiment of TAP 1400 shown in FIG. 14 is for illustration only. Other embodiments could be used without departing from the scope of this disclosure.

In general, the transient access point (TAP) 1400 functions in a relatively similar manner to a BS or an access point, yet is configured to operate periodically, thus operating according to a duty cycle. Additionally, the TAP 1400 communicates wirelessly with a core network and can be self-sufficient in energy use. That is, the TAP 1400 may include its own power source, such as one or more solar cells. In this manner, the TAP 1400 has enhanced portability in that it is not limited to only those locations having a viable power source. In certain embodiments, Transient access points (TAPS) are deployed to increase a deployment density of a wireless network in which they are configured.

The TAP 1400 includes an energy generation module 1402, an energy storage module 1404 (e.g., a battery), a communication module 1406, and a control module 1408. The energy generation module 1402 includes any suitable stand-alone source of power, such as a solar power module, a wind power module, or power generation modules using other energy harvesting techniques. The power generated by the energy generation module 1402 can be either fed directly to the communication module 1406 or to charge the energy storage module 1404. The low duty cycle of the TAP allows the energy generation module 1402 to be sufficiently small to ensure a small form factor of the overall device. The energy storage module 1404 provides power for the communication module 1406 when the energy generation module 1402 is not able to provide power, such as during nighttime when a solar power module is used. The control module 1408 can interact with the other modules via control signals.

In general, a transient access point (TAP) is an access point (or base station) that is only turned on for a portion of the time. In some cases, the duty cycle of the TAP is relatively low. In addition, a TAP does not require any wired backhaul link to be connected to the core network. Preferably, a TAP is also self-sufficient on its energy use.

In certain embodiments, the “ON” time (e.g., duty cycle) of the TAP 1400 is adapted to be large or small. The duty cycle can be configured, indicated, updated and sent to the other network entities such as base stations, mobile stations, hubs, and the like. The network can configure or update the duty cycle of the TAP 1400 based on considerations in the network such as loading levels, distribution of the mobile stations (MSs) the network, and the like.

In some cases, the TAP 1400 is configured to use external power. For example, when the power generated by the energy generation module is not sufficient, the TAP 1400 uses external power rather than the power provided by its energy generation module 1402 or energy storage module 1404. In certain embodiments, the control module 1408 executes a scheduling algorithm to calculate when the energy storage module 1404 should be used, when the energy storage module 1404 should be charged, and when the external power should be used, based on various factors, such as the price of the external power, which may be provided via the smart meters and the like.

The storage level of the energy storage module 1404 can be measured and transmitted to other network devices such as base stations, mobile stations, hubs, and the like. The storage level indication can be, for example, the percentage of the battery available level, the time to run if using battery, whether the TAP is plugged in with power supply from power line, and the like.

The storage level of TAP 1400 can be used as one among multiple factors to determine the route of a wireless backhaul link. The storage level of the TAP 1400 also can be used by a MS to determine whether to use the TAP to access the network. For example, when the battery level of a TAP is low, a MS chooses not to connect to the TAP. Rather, the MS chooses to connect to another TAP nearby having a greater energy storage level. For another example, a BS or other TAP chooses not to connect to a TAP with a low battery level, but chooses to connect to a TAP with higher battery level, for a hop of the backhaul route.

In certain embodiments, the TAP is void of an energy generation module if power is readily available at the site on which the TAP is deployed. Additionally, in some embodiments, the TAP 1400 is provided with a wired backhaul connection. In this manner, TAPs can improve wireless network capacity and coverage in some embodiments.

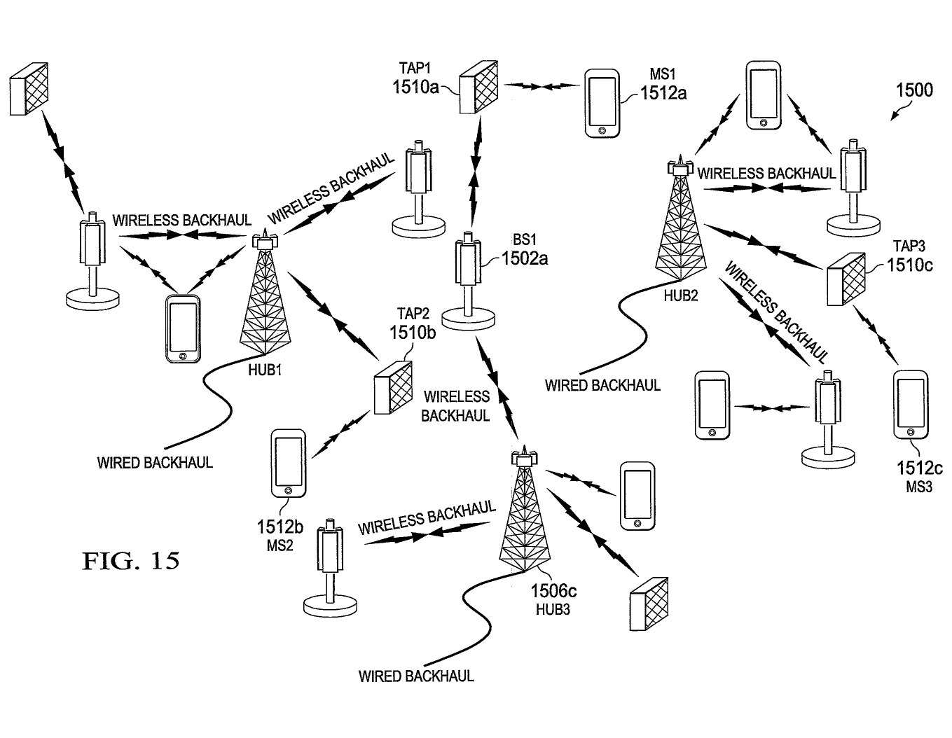

FIG. 15 illustrates an example wireless backhaul communication system 1500 according to the teachings of the present disclosure. The embodiments of the wireless backhaul communication system 1500 shown in FIG. 15 are for illustration only. Other embodiments could be used without departing from the scope of this disclosure.

Wireless backhaul communication system 1500 illustrates an example of that TAPs 1510 improve wireless network capacity and coverage. The system 1500 includes one or more mobile stations (MSs) 1512 that communicates to the network via one or more TAPs 1510, base stations (BSs) 1502 and hubs 1506.

In certain embodiments, TAPs can improve wireless network capacity and coverage. Due to the low duty cycle capability provided by the TAPs 1510, only a small number of the TAPs in the network can be turned on at a time. When a TAP 1510 is turned on, it establishes wireless backhaul link to the core network via hubs or base stations. The communication link between a TAP 1510 and a base station 1502 or a hub 1506 can be established via beamforming using adaptive antenna arrays at both the TAP 1510 and the base station 1502 or the hub 1506.

A TAP 1510 can also establish multiple links with multiple base stations 1502 or hubs 1506. Once the backhaul link 1504 is established, a TAP 1510 can then provide access link to mobile stations. As shown, BS1 1502a establishes a wireless backhaul link with Hub3 1506c. TAP1 1510a establishes wireless backhaul link with BS1 1502a. MS1 1512a establishes communication link with TAP1 1510a. These links enable MS1 1512a to access the network via the route MS1 [symbol] TAP1 [symbol] BS1 [symbol] Hub3. Likewise, MS2 1512b can access the network via the route MS2 [symbol] TAP2 [symbol] Hub1, while MS3 1512c can access the network via the route MS3 [symbol] TAP3 [symbol] Hub2. The presence of TAP1 1510a, TAP2 1510b, and TAP3 1510c increase the deployment density of the network and thus can increase the capacity and/or coverage of the access link (e.g., the link between an MS and network nodes or network entities such as a TAP, a BS, or a Hub). Throughout the disclosure, we use network node and network entity interchangeably.

Throughout the disclosure, a network node or network entity may include any device configured to transmit and receive communication traffic. For example, a network entity may include a hub, a base station, a base station which is connected to a hub, a base station which can relay backhaul traffic to a hub, a first base station which can relay backhaul traffic to a second base station, a first base station which can communicate traffic for coordination in-between base stations to coordinate with a second base station, a mobile station, a gateway, an entity in an access network or an entity as part of an access network, an entity that is connected to a core network, an entity that is part of a core network, an entity belonging to a backhaul, and the like. An access network can be that part of a communication network that connects subscribers to their immediate service provider. A core network can be the central part of a communication network that provides services to customers who are connected by the access network. A core network may include communication facilities that connect primary nodes in the entire communication network. A backhaul can comprise the intermediate links between the core network and access network or sub-networks at the edge of the entire network.

If certain conditions are met, such as the interference level from a current superordinate base station is higher than a threshold, an access point, such as a TAP that desires a wireless backhaul link can choose another superordinate base station that can provide satisfactory link quality such as a satisfactory level of interference. The access point, such as the TAP can monitor and measure the candidate superordinate base stations in which the choice of selection of the superordinate base station can be based on the measured result. The measurement can be any suitable type, such as an interference level, a signal strength level, SIR, SINR, SNR, and the like. The interference can include the interference from the base stations, the mobile stations, and the like. The measurement can also include traffic statistics such as throughput, buffer size, delay, and the like.

In certain embodiments, a TAP may be configured to report the measured results periodically to a superordinate base station. In certain embodiments, a superordinate base station may send signaling messages to request a TAP to report certain measurement results. In certain embodiments, a TAP may send certain measurement reports and/or request for interference coordination if certain triggers are met.

The superordinate base station or the network can use the measured reports from the TAPS to manage or reconfigure the TAPs to enhance capacity management and interference coordination. For example, the network may detect the load in a certain area has crossed a certain threshold and thus wake up at least one TAP to increase the capacity in that area. As another example, by using the measured reports from the TAPs and base stations, the network can determine that a certain base station or a certain hub is congested. The network may then reconfigure the network routing or topology to mitigate the congestion. For example, the network may reconfigure or re-route some packets from some UEs or TAPs or base stations such that the traffic going through the congested TAPs, base stations, or hubs is reduced.

In certain embodiments, the TAP can respond to various algorithms and triggering conditions to turn on or off. Different modules in a TAP do not have to turn on or turn off at the same time. For purpose of illustration, we use the communication module of a TAP as an example to describe the mechanisms to turn on and turn off a TAP or a module in a TAP. But the description can be applicable to the whole TAP or other modules in a TAP (e.g., a control module) as well. The communication module of a TAP can be turned on (or become active in serving mobile stations) via a variety of mechanisms. Note that the energy generation module of a TAP can work both when a TAP becomes idle or active.

In certain embodiments, the communication module of a TAP is configured to be turned on or to become active in serving mobile stations for a specified period of time. For example, multiple TAPs can be deployed in along streets or highways that experience peak usage periods, such as during rush hour. Because TAPs do not require a wired backhaul link or a power line, TAPs can be conveniently deployed in a manner to provide high deployment density. In certain embodiments, the pattern of peak usage can be observed. In certain embodiments, the communication module of the TAPs in those areas can be configured to turn on or become active in serving mobile stations during these periods of peak usage.

FIG. 16 illustrates an example method 1600 of turning a TAP on or off according to certain embodiments of the present disclosure. FIG. 16 illustrates an example of state transition between ON/ACTIVE and OFF/IDLE at pre-configured time for TAPs.

In step 1602, the TAP is in an IDLE or OFF state.

In step 1604, the TAP determines whether or not it comes the time to be ON or active. If so, processing continues at step 1606; otherwise processing reverts back to step 1602.

In step 1606, the TAP goes to the ON or active state.

In step 1608, the TAP determines whether or not it comes the time to be OFF or IDLE. If so, processing continues at step 1602; otherwise processing reverts back to step 1606 in which the TAP continues in the ON state.

The above process continues throughout operation of the TAP.

In certain embodiments, the communication module of a TAP can be turned on or become active in serving mobile stations via certain paging or wake-up mechanisms. For example, when the communication module of a TAP enters the idle state, the communication module of the TAP may wake up periodically to monitor certain paging signal or activation/wake-up signal. Both hubs and base stations can transmit paging signals or activation/wake-up signals. The paging signals or activation/wake-up signals can be designed to wake up either a group of TAPs or a specific TAP. The time, frequency, and/or signal that a TAP should wake up to monitor can be configured and this configuration is preferably known to both the TAP and the network so that the network knows how to page/activate/wake up the communication module of a TAP.

The TAP paging or wake-up signal can be transmitted in the wireless backhaul system. Alternatively, the TAP paging or wake-up signal can be transmitted in the air interface system. Since TAPs can be configured to be immobile, the network may have the knowledge of the location of a TAP and transmit paging or wake-up signal to the TAP only via a single node (hub or base station). Alternatively, the network may broadcast a paging or wake-up signal in an area where more capacity is needed to wake up multiple TAPs. The paging or wake-up signal may contain certain threshold to be used by the state transition algorithm in a TAP to determine whether to become active or not. In a TAP, a metric can be calculated and compared with a threshold. The TAP only turns on if the metric surpass the threshold. The metric can be a function of a variety of parameters such as priority of the TAP, the past activities of the TAP, the battery level of the TAP, the energy charging rate of the TAP, etc. For example, the paging or wake-up signal may contain a energy level threshold such that a TAP should only become ON if it has a certain amount of energy stored or can stay ON for a certain amount of time.

In another embodiment of the invention, the communication module of a TAP can turn off or become idle (i.e., stop serving mobile stations) via certain triggering mechanism. For example, the communication module of a TAP can become idle once the load of the TAP or the network falls below a certain threshold. As another example, the network may send a message to instruct a TAP to become idle. As yet another example, the communication module of a TAP can become idle once the stored energy in the battery module falls below a certain threshold.

FIG. 17 illustrates an example method of turning a TAP on or off according to certain embodiments of the present disclosure. FIG. 17 illustrates an example of trigger based state transition between ON/ACTIVE and OFF/IDLE for TAPs.

In step 1704, the TAP is in an IDLE or OFF state.

In step 1706, the TAP determines whether to monitor a paging signal. If so, processing continues at step 1708; otherwise, processing reverts to step 1704.

In step 1708, the TAP determines whether a transition has been triggered for moving from the OFF state to the ON state. If so, processing continues at step 1710; otherwise, processing reverts back to step 1704. In step 1710, the TAP is in the ON or ACTIVE state. In step 1712, the TAP determines whether a transition has been triggered for moving from the ON state to the OFF state. If so, processing continues at step 1704; otherwise, processing reverts back to step 1710.

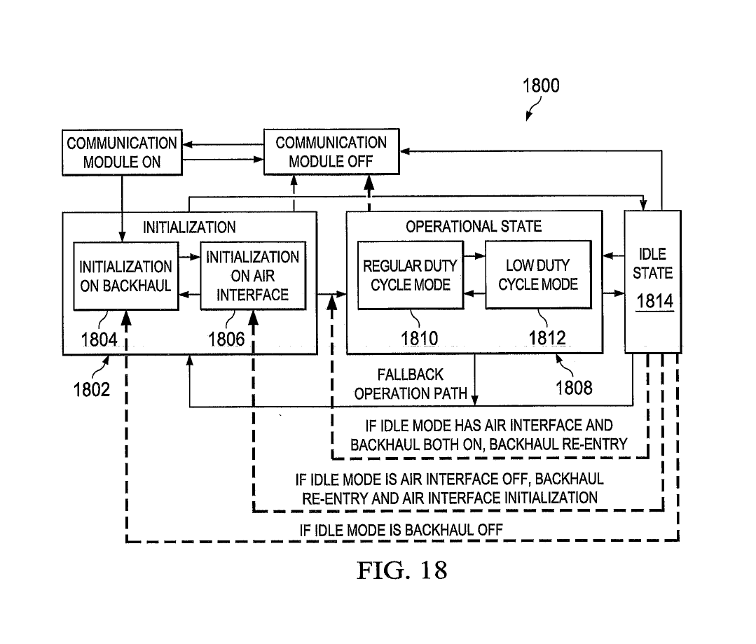

FIG. 18 illustrates an example state transition diagram 1800 including various states in which the TAP may exist during its operation according to one embodiment of the present disclosure. In certain embodiments, the TAP simultaneously exists in multiple states, including power on state, initialization state, operational state, idle state, power off state, and the like. In certain embodiments, some states, such as idle state, are omitted.

The diagram 1800 includes an initialization state group 1802 including an initialization on backhaul state 1804 and an initialization on air interface state 1806. The diagram 1800 includes an operational state group 1808 including a regular duty cycle mode 1810 and low duty cycle mode 1812. The diagram 1800 includes an idle state 1814. When communication module is from OFF to ON, the state can go back to OFF, or it can go to the initialization state. After the initialization state 1802, the state goes to the operational state 1808, or it can go to the idle state 1814. After the operational state 1808, it can go to the idle state. Each of the initialization state, operational state, and idle state can go to the communication OFF state. Each of the operational state, idle state can fall back to the initialization state. From the idle state, if the idle state mode has air interface and backhaul both on, the idle state can go back to the operational state by performing a backhaul re-entry, without initialization on both the backhaul and the air interface. From the idle state, if the idle state mode is air interface off, the idle state can go back to the initialization on air interface, and a backhaul re-entry is needed. From the idle state, if the idle state mode has backhaul off, then the idle state should go back to the initialization on backhaul. The backhaul interface of a network node (such as a TAP) refers to the interface in-between the said network node and at least one of its superordinate network node in the direction towards the core network, and the air interface refers to the interface in-between the said network node and a mobile station or at least one of its subordinate network node in the direction away from the core network.

In certain embodiments, an initialization state 1802 can include an initialization on backhaul state 1804 and an initialization on air interface state 1806. The initialization on backhaul state 1804 carries out a procedure of how the TAP is initialized to communicate to the backhaul network, while the initialization on air interface state 1806 carries out a procedure of how the TAP is initialized to communicate with one or more mobile devices. In certain embodiments, when the communication module of the TAP is powered on, it first performs the initialization of a backhaul network to arrive at state 1804. Once the backhaul is set up, the TAP can then initialize an air interface to arrive at state 1806. In some embodiments, these two initialization procedures are performed in an opposite sequential order, simultaneously with respect to one another, or are interactively performed.

With regard to state 1804, initialization on the backhaul may be performed in different ways. For example, one backhaul initialization includes a direct approach in which the TAP couples directly to the network through a superordinate BS. In some cases, this direct approach requires that the superordinate BS has been already initiated so that the TAP scans and finds such a wireless backhaul interface to start network entry. The direct initialization approach can be useful in inband situations where the MS/BS and BS/BS communications share the same frequencies. This also can be useful for outband wireless backhaul situations in which the MS/BS and BS/BS communications use different frequencies. Another initialization approach includes a pre-initialization performed on the backhaul link followed by another following initialization of the backhaul link. For example, the TAP can be configured to function like a MS to communicate to communicate with a target BS using a first set of frequency carriers, and then the TAP can communicate with the target BS using a second set of frequency carriers for the wireless backhaul initialization. This can also be used for inband wireless backhauling.

In the initialization of the backhaul link, the TAP attempts to establish backhaul connectivity. The TAP performs next hop (towards the core network) base station selection by scanning, synchronizing and acquiring system configuration information of the network. The TAP may discover one or more base stations that can be used as the next hop node for connection to the network, and the TAP chooses one or more base stations from which it directly communicates. The TAP uses any suitable algorithms or rules to select the next hop BSs or directly connected BSs.

In certain embodiments, the TAP uses a pre-backhaul initialization technique to search for the next hop BSs. The pre-backhaul initialization is used to find out where to look for BSs having wireless backhaul superordinate service capability, and/or where the wireless backhaul link resources are located. In certain embodiments, the TAP functions like a MS to scan the frequency carriers for establishing BS-MS communications, and/or attempting to find candidate BSs. The candidate BS sends certain information indicating whether it has the capability to provide a wireless backhaul service, such as whether the candidate BS can be a superordinate node for other nodes, or certain information indicating whether the wireless backhaul service is currently in an ON or OFF state, and/or where the wireless backhaul resources are located. If the candidate BS has such a capability and the wireless backhaul service is off, then the TAP tries to signal the BS to initiate the backhaul service during its network entry to the candidate BS. The signal is known by the BS such that the BS is able to recognize it is for the request of wireless backhaul service initialization. By initiating the backhaul service, the BS sends synchronization channel information, broadcast channel information, and the like over the resources on the wireless backhaul service, so that when the TAP scans for the BS on the resources of wireless backhaul at a later time, the TAP successfully discovers the BS.

In certain embodiments, the TAP does not use a pre-backhaul initialization to search for the next hop base station. The TAP directly scans the possible BSs that can serve superordinate nodes on the resources (e.g., carrier frequency, frequency, time, space, etc.) or the interface for the wireless backhauling. The TAP already knows the resources for the wireless backhauling, such as, by predetermined method, or by cached information, or by saved information, and the like. Some BSs that have the capability of serving superordinate node may already have initiated or be using the wireless backhaul service, such that the synchronization channel, broadcast channel, and the like, are already sent over the resources for the wireless backhaul service.

In certain embodiments, the TAP attempts to perform the direct backhaul initialization approach first, and, if it does not find any superordinate BS, then the TAP goes to the pre-backhaul initialization, where the TAP signals multiple BSs to initiate the superordinate wireless backhaul service.

Once the TAP knows the resource locations of the wireless backhaul links, and one or more BSs are discovered having the capability of a serving superordinate node, the TAP scans the resources for the wireless backhaul service, to perform superordinate base station selection by scanning, synchronizing and acquiring the system configuration information. It finds one or more BSs that are used as the next hop for connection to the network, and it chooses one or more BSs as the target base station(s). Via the chosen target base station(s), it can establish the backhaul connectivity.

The TAP then performs network entry with the target BSs via the wireless backhaul interface. Network entry generally includes a multi-step process including steps, such as ranging or random access, basic capability negotiation, authentication, authorization, key registration with the target base station(s) and network, and service flow establishment, and the like. The TAP receives its station identifier, which is used by the target base station to identify the TAP and communicate with the TAP, and establishes at least one connection. The target BSs and the network sends the communication context information to the TAP, such as the information of the neighboring cells, the routing tables for the backhaul, and the like. If cached information about the target BSs is available, the TAP attempts network entry with the cached target BSs.

During this state, if the TAP cannot properly perform the system configuration information decoding and cell or base station selection, the TAP falls back to performing a scanning and downlink (DL) synchronization approach. If the TAP successfully decodes the system configuration information and selects a target BS, the TAP continues with the network entry process. Upon failing to complete any one of the steps of network entry, the TAP repeats the steps or falls back to BS selection by scanning, synchronizing and acquiring the system configuration information.

Regarding the initialization on the air interface state 1806, procedures like configuration of air interface parameters and time/frequency synchronization are performed. The TAP will perform multiple steps, such as power on the air interface with proper power, use the proper frame structure, configure air interface parameters, choose a preamble for the synchronization channel, start transmitting e.g., synchronization channel and physical broadcast channel, secondary broadcast channel or the system information blocks, and the like. In certain embodiments, the air interface parameters are negotiated with the backhaul network. For example, the preamble of the synchronization channel can be assigned by the backhaul network, or the TAP can choose a preamble. If the TAP chooses the preamble, the TAP is configured to let the backhaul network confirm this choice of preamble.

In certain embodiments, an operational state 1808 can include a regular duty cycle mode 1810 and a low duty cycle mode 1812. The TAP enters the operational state 1808 following initialization of states 1804 and 1806. When in the operational state 1808, if the TAP becomes unattached to the service providers network or if it fails to meet operational requirements (which may include failed synchronization), the TAP reverts back to the Initialization State. In the operation states 1810 and 1812, the TAP maintains the air interface link to its MS, and the wireless backhaul interface to its superordinate BS.

Using the air interface link to the MS, the TAP uses an air interface similar to other BSs such as those used by small cell BSs. In the low duty cycle state 1812, the TAP reduces air interface activity in order to reduce interference to neighbor cells. Also in this state, the TAP can repeatedly alternate between an available and unavailable interval. For example, if no MS is currently being served by the TAP, the TAP can transition to the low duty cycle state 1812.

On the wireless backhaul link, the TAP monitors the link quality, as well as other neighboring BSs, and switches the wireless backhaul link to a BS according to the monitored link quality. In this manner, relatively good reliability is achieved by continually adapting the wireless backhaul link according to changing network conditions.

The TAP remains in either operational mode 1810 or 1812 during a hand over to another superordinate BS on the wireless backhaul interface. The TAP exists in other states while having an active wireless backhaul link, such as a sleep state, an active state, and a scanning state. In the active state, the superordinate BS schedules the TAP to transmit and receive at the earliest available opportunity provided by the protocol; that is, the TAP is assumed to be available to the superordinate BS. The TAP requests a transition to either the sleep or scanning state from the active mode. Transition to the sleep or scanning mode occurs in response to a command from the superordinate BS.

In certain embodiments, when in the sleep state, the TAP and superordinate BS agree on the division of the radio frame with regard to sleep windows and listening windows. The TAP is only expected to receive and process transmissions from the superordinate BS during the listening windows. Additionally, any protocol exchange is to be initiated during that time. Transition of the TAP to the active mode is prompted by control messages received from the superordinate BS. When in the scanning state, the TAP performs measurements as instructed by the superordinate BS. The TAP may or may not be unavailable to the superordinate BS while in the scanning state. The TAP returns to the active state once the duration negotiated with the superordinate BS for scanning expires.

For the TAP, the communication state of the air interface links to an MS and the wireless backhaul interface link may or may not be coordinated. Some coordination of the states can occur. For example, when the air interface is on the low duty cycle mode 1812, the TAP spends a significantly long time being inactive, while spending a relatively short time in the active mode.

The TAP transitions from the operational state 1808 to the idle state 1814. Such a transition is based on a negotiation of the TAP and the superordinated BS or the network. For example, if the TAP does serve any MS for a specified period of time or the TAP does not have sufficient energy stored in its battery, the TAP requests or initiates an idle state transition. A command from the superordinate BS is used for the TAP to perform the transition. The TAP is deregistered if the wireless backhaul link is not required.

Failure to maintain the link prompts the TAP transition to the initialization state 1802. Depending upon which connection is used, i.e., the air interface link or the wireless backhaul interface, different initialization steps can be applied accordingly.

The TAP, in the idle state 1814, has different functional aspects. In certain embodiments, the functional aspects may include any combination of the following: 1) the air interface link to one or more MSs is either ON or OFF, 2) the wireless backhaul link to a BS is either ON or OFF, and 3) the connection level of the TAP to the BS is either ON or OFF. Accordingly, a total of eight different combinations of functional aspects (e.g., aspect 1 (1 OFF, 2 OFF, 3 ON), aspect 2 (1 OFF, 2 ON, 3 OFF), aspect 3 (1 OFF, 2 ON, 3 ON) are provided in the idle state 1814.

In the functional aspect 1 of the idle state 1814, the TAP performs essentially similar to an MS communicating with other BSs. The Idle state includes two separate modes, namely a paging available mode and a paging unavailable mode based on its operation and MAC message generation. During the idle state, the TAP performs power saving by switching between the paging available mode and the paging unavailable mode. The TAP is paged by the network or BSs. The paging is used for waking up the TAP so that it proceeds to the initialization state 1802.

In the functional aspect 2 of the idle state 1814, the TAP maintains the wireless backhaul link with other BSs in the idle state, that is, all wireless links to any MSs are dropped. When leaving this functional aspect 2, the TAP re-enters the active state via the initialization procedure as described herein above. The TAP's backhaul interface link to its superordinate node can have limited activity (similar to an MS in idle) such as listening to the system information and paging information from the superordinate node. A wireless backhaul link re-entry procedure, in some cases, is simpler than the initialization and initial network entry of the TAP. The network finds the TAP and wakes up the TAP if needed, such as when offloading of traffic to the TAP is needed, or some MSs are discovered to be within the servicing region of the TAP based on location information known about the MSs.

In the functional aspect 3 of the idle state 1814, both the air interface link and the wireless backhaul link are ON. In this manner, the TAP performs similar to a conventional BS. The TAP's backhaul interface to its superordinate node has limited activity (similar to an MS in idle) such as listening to the system information and paging information from the superordinate BS. The TAP's air interface to one or more MSs exists with limited communication, such as synchronization, and/or major broadcast channel communication. When the TAP wakes up, a network re-entry procedure is used to re-establish the wireless backhaul link.

Multiple techniques are used to wake up the TAP to exit the idle state 1814. For example, an MS wakes up the TAP via an air interface between the MS and the TAP, such as by using uplink signaling to which the TAP would listen. As another example, the network or the subordinate BS of the TAP pages the TAP to wake it up via the wireless backhaul link.

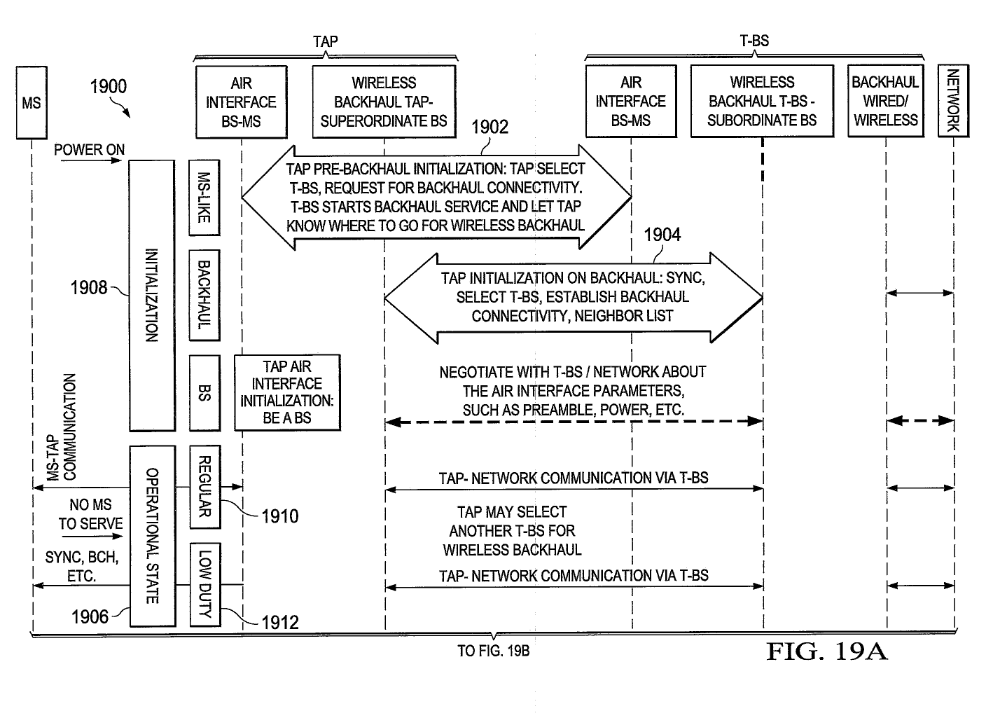

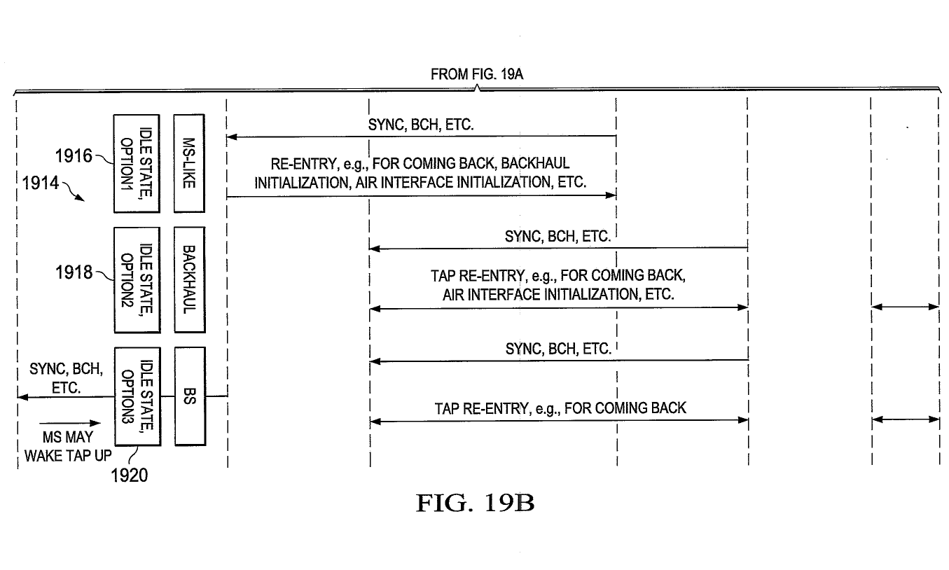

FIG. 19 illustrates an example communication procedure that may be performed by the TAP according to certain embodiments of the present disclosure. The example communication procedure of the TAP shown in FIG. 19 is for illustration only. Other embodiments could be used without departing from the scope of this disclosure.

In the example illustrated in FIG. 19, two initialization states are provided. One initialization state includes initialization on the backhaul link 1904 (e.g., how the TAP would be connected to the backhaul network) which may also have a TAP pre-backhaul initialization 1902, and the other initialization state includes an initialization on the air interface (e.g., the air interface of TAP and mobile devices). When the TAP is powered on, it may first perform a TAP pre-backhaul initialization 1902, in which the TAP may work like a mobile station (MS) trying to get some initial access to the network via at least one of a nearby base station. The TAP may have a mobile station unit for the TAP to work like an MS. The TAP pre-backhaul initialization can include the procedures such as selecting target base station (T-BS) via which that the TAP can establish backhaul connectivity, requesting for backhaul connectivity, and the like. The target BS can start backhaul service and let the TAP know the resources for wireless backhaul. After the TAP pre-backhaul initialization, the TAP can have the initialization of the backhaul with the target base station. The procedure can include synchronization, selecting a target base station, establishing backhaul connectivity, neighbor list, and the like. The TAP can further negotiate with the network about the air interface parameters, such as preamble, transmitting power, and the like. The TAP can carry out the air interface initialization and after that the TAP can be visible to the mobile stations. The TAP can be in the operational state 1906. The TAP can be in regular operational state 1910. If certain conditions are met, such as there is no MS to serve, the TAP can be in the low duty mode 1912. The TAP can be in the idle mode 1914, where the idle mode can have different configurations, such as those options in 1916, 1918, or 1920. For each of these options, some of the message flows are shown in FIG. 19.

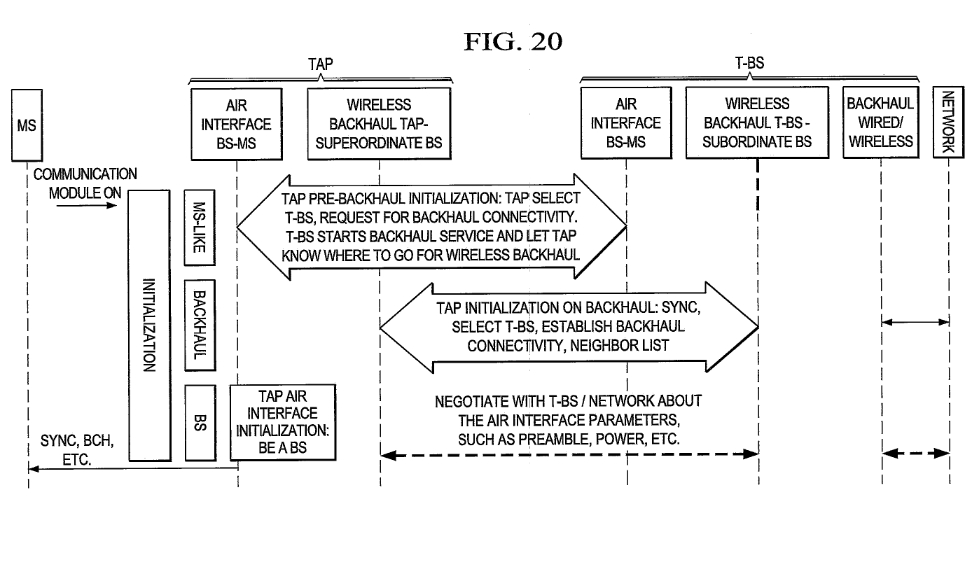

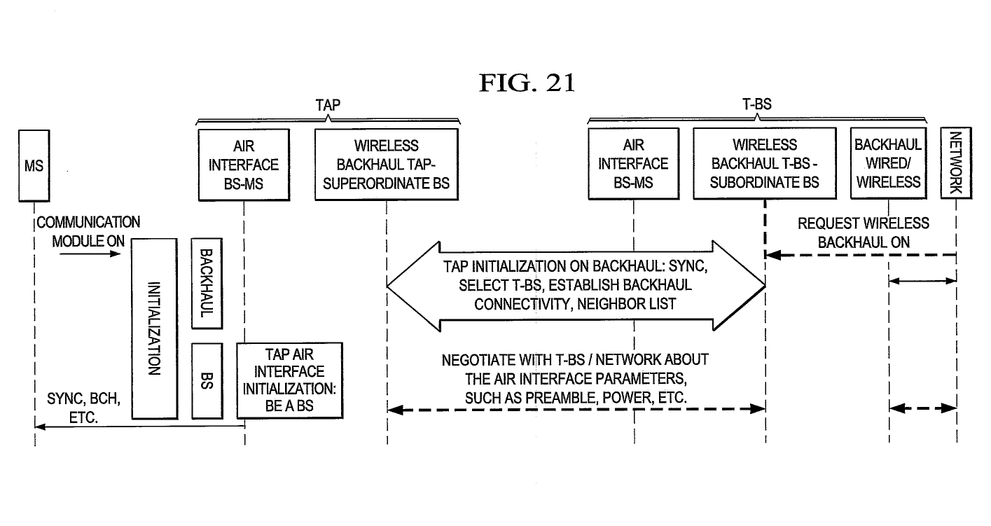

FIGS. 20 and 21 illustrate example initialization procedures that may be performed by the TAP according to certain embodiments of the present disclosure. The embodiments of the initialization procedures that may be performed by the TAP shown in FIGS. 20 and 21 are for illustration only. Other embodiments could be used without departing from the scope of this disclosure.

As shown in FIG. 20, the TAP can perform a pre-backhaul initialization followed by an initialization of the backhaul link. Conversely, as shown in FIG. 21, the TAP can be initialized directly from the backhaul interface.

Referring again to FIG. 19, when in the Operational State 1906, if the TAP becomes unattached to the service providers network or if it fails to meet operational requirements, such as by a failed synchronization, it reverts to the Initialization State 1908. In the Operational State 1906, the TAP maintains the activity on both the air interface to its MS, and the wireless backhaul interface to its superordinate BS.

On the air interface to its MS, the TAP may use the similar air interface as the other BSs such as other small cell BSs. In the Operational State, normal operation 1910 and low-duty operation modes 1912 can be supported. In low-duty mode 1912, the TAP reduces air interface activity in order to reduce interference to neighbor cells. In the low-duty mode 1912, the TAP can alternate between an available and an unavailable interval (i.e., low-duty operation cycle). If there is no MS to be served, such as no MS in the serving area, or no MS is trying to access the TAP, then the TAP can get into the low duty mode 1912.

The TAP may transition from the Operational State 1906 to an Idle State 1914. Such a transition may be based on a negotiation of the TAP and the superordinated BS or the network. For example, if for a certain time the TAP does not have any MS to serve, or TAP does not have enough energy left in the battery, the TAP may request or initiate an idle state transition. A command from the superordinate BS may be used for the TAP to perform the transition. The TAP may be deregistered if in the idle state the wireless backhaul link is not required.

Failure to maintain the connections can prompt the TAP to transition to the Initialization State 1908. Depending on which connection, such as the air interface or the wireless backhaul interface, different initialization steps can be applied accordingly.

The Idle State can function according to various options. For example, the Idle State 1914 can be any combination of the following: i) TAP air interface (connection of TAP-MS) ON or OFF, ii) TAP wireless backhaul (connection of TAP-wireless backhaul and T-BS subordinate wireless backhaul) ON or OFF iii) connection of TAP functioning like a MS, and T-BS air interface ON or OFF.

In the above example, the TAP may function according to eight different combinations, e.g., option 1 (1 OFF, 2 OFF, 3 ON), option 2 (1 OFF, 2 ON, 3 OFF), option 3 (1 OFF, 2 ON, 3 ON), and the like. As shown, three options out of the possible eight as shown. Nevertheless, other embodiments may have more, fewer, or different types of options.

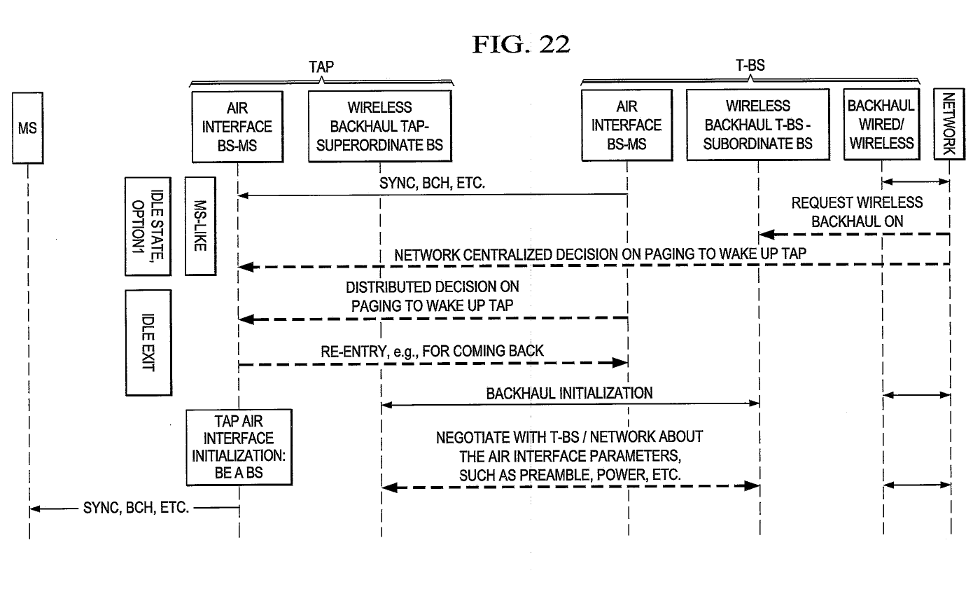

FIGS. 22 through 24 illustrate several example idle states the TAP may function in according to certain embodiments of the present disclosure. The embodiments of the initialization procedures that may be performed by the TAP shown in FIGS. 22 through 24 are for illustration only. Other embodiments could be used without departing from the scope of this disclosure.

As shown in FIG. 22, the TAP can, while in the Idle State, function like a MS. In this particular option, multiple techniques can be used to wake up the TAP to exit the idle state, for example, the network or the subordinate BS of the TAP may page the TAP to wake it up via wireless backhaul.

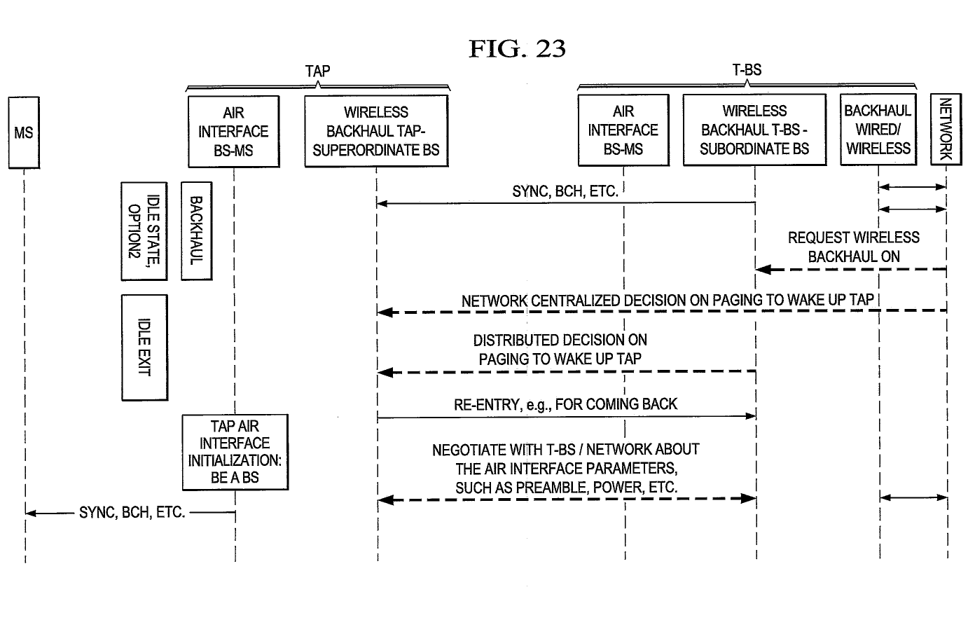

As shown in FIG. 23, the TAP can have an active backhaul link while in the Idle State. While in this state, multiple techniques can be used to wake up the TAP to exit the idle state, for example, the network or the subordinate BS of the TAP may page the TAP to wake it up via the wireless backhaul link.

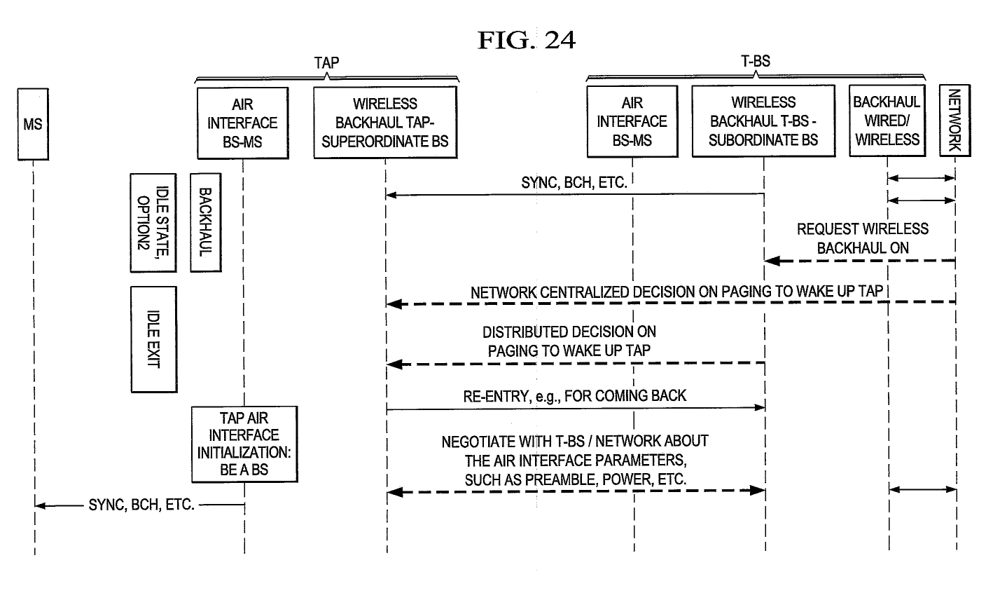

As shown in FIG. 24, the TAP can, while in the Idle State, function like a BS. In this particular state, the TAP may function with both the air interface and backhaul link being active.

In certain embodiments, a slow power up for the air interface of TAP is applied. For example, the TAP is powered up by adding a certain amount of power over a given time, such that interference with other operating terminals, such as any active MSs is avoided. If no active MSs exist within the cell coverage of the TAP, then the slow power up procedure is not used. If the network or a particular BS has knowledge of the location of the TAP, the BS suggests a power value for the TAP air interface with which the TAP should start.

In certain embodiments, the network notifies MSs within the cell coverage of the TAP to become prepared for a handover if a TAP is powering up. For example, if the network knows that certain MSs would experience undue interference by a power up of a TAP based on the locations of TAP and MSs, the network transmits a message to the MS suggesting that the MS attempt to perform a measurement of the TAP being powered up.

In certain embodiments, messages received from and transmitted to the TAP are differentiated from messages used by other base stations, e.g., by preambles, indications in the broadcast channel, and the like. Identification of the TAP using these messages is used to form a backhaul route, or for the MS to select or reselect cells.

In certain embodiments, routes through the network using the TAP are formed in a distributive manner or a centralized manner. In other words, a node, such as a TAP, a base station, or a hub, builds its routing table based on traffic statistics, measurement reports, and a set of rules, protocols, and/or algorithms. Alternatively, the network has a centralized controller that determines the routing mechanism of multiple nodes jointly based on the overall network traffic statistics and measurements. The routing mechanism, such as a routing table of a node, is a function of one or more of signal strength/SINR/SIR/link quality, backhaul condition, battery level, BS type, load, distribution of the MS, and the like.

In one embodiment, the TAP is configured to perform a deregistration procedure through the backhaul network. For example, when the TAP goes to idle state, the TAP performs the TAP deregistration procedure.

In the case of a power down procedure of the TAP, the TAP sends out-of-service information to any MSs that it is servicing. Before powering down or changing to the initialization state, the TAP requests the MSs to perform a handover to neighbor cells. When the backhaul link of the TAP is down or the connection with the service provider network is lost for a configurable specified amount of time, the TAP considers itself to be not attached to the network. In such a case, before transitioning to the initialization or powered down State, the TAP disables the air interface to the MSs as soon as the connection with the service provider network is lost. Before disabling the air interface, the TAP broadcasts a message to inform the MSs of such an event. The TAP supports certain mechanisms to ensure service continuity of the MSs prior to disabling its air interface. For example, a BS initiated handover to help MS handover to other cells is used. When a TAP is going to disable the air interface, it transmits information that bars MSs from entry into the cell administered by the TAP. The TAP broadcasts the barring information through a message with appropriate reason indications, repeatedly until it disables the air interface. If a handover is to be performed, the indicator also informs whether the handover will be coordinated or not for the MSs to decide which handover procedure will be performed.

When the power down procedure is experienced by the TAP, it notifies the power down procedure to the network, then the network helps choose other BSs for the MSs based on the locations of TAP and MSs.

In certain embodiments, the superordinate BS wireless backhaul interface to the subordinate BSs such as TAPs can operate under multiple modes, such as ON, initialization, regular operation, low duty operation, and OFF, and the like. These modes can be switched or transited semi-statically, statically, or dynamically. The superordinate BS wireless backhaul interface can be in a low duty mode, which can have limited transmission functionality, such as only transmitting the synchronization channel and some broadcast channel algorithms. Alternatively, the TAP can be in an OFF mode where the wireless backhaul of the superordinate BS is not in service (i.e., OFF) if certain conditions are met, such as no TAPs attempting to access the superordinate BS for the backhaul. The network wakes up the superordinate BS wireless backhaul interface if the TAP would be using the wireless backhaul service, or the TAP wakes the superordinate BS wireless backhaul interface, which is in a low duty mode or OFF mode via some signaling technique. The network coordinates the wake up timing for the TAP and the superordinate BS wireless backhaul interface. For example, the network wakes up the superordinate BS or requests that the superordinate base station initializes or starts the wireless backhaul interface to the subordinate BS such as the TAP. In this manner, the TAP is also awakened to find out the superordinate BS wireless backhaul link. For another example, the TAP is ON first, then the TAP communicates the network and the network wakes up the superordinate BS wireless backhaul interface.

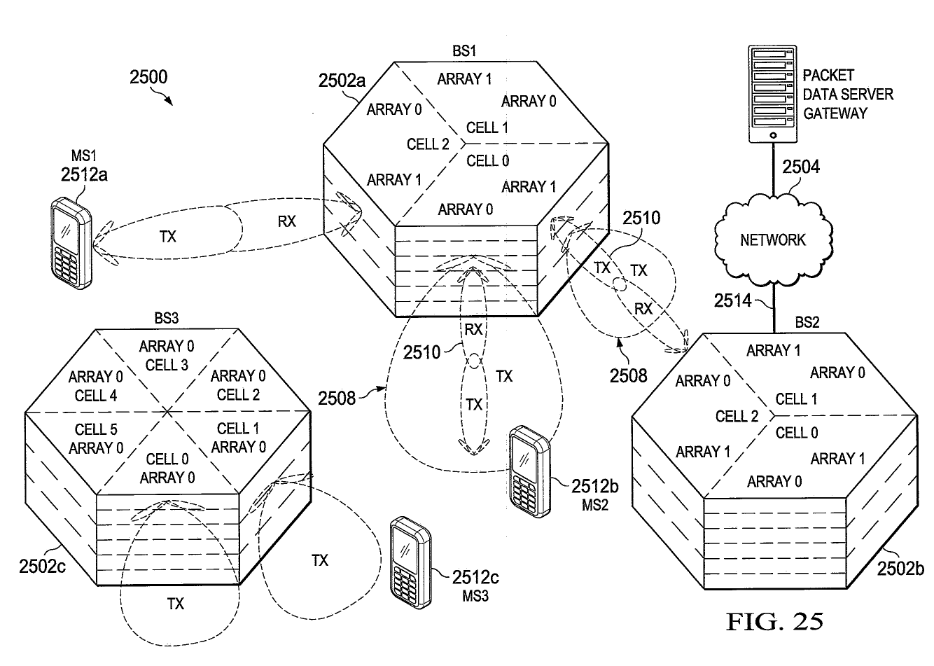

FIG. 25 illustrates an example wireless communication network 2500 according to certain embodiments of the present disclosure. The embodiment of the wireless communication network 2500 shown in FIG. 25 is for illustration only. Other embodiments could be used without departing from the scope of this disclosure.

The wireless communication system 2500 includes three BSs 2502a, 2502b, and 2502c that communicate with a core network 2504. Each BS 2502a and 2502b operates with three cells cell0, cell1, and cell2, and BS 2502c has six cells. Each cell of BS 2502a and 2502b includes two arrays array0 and array1 configured to form beams. Each cell of BS 2502c has one array. The wireless communication between base station BS 2502a and base station BS 2502b as wireless backhaul communication (i.e., BS-BS), and the wireless communication between base station BS1 and MS as access communication (i.e., BS-MS).

Arrays array0 and array1 of cell0 of base station BS 2502a have the same downlink control channels transmitted on a relatively wide beam. In certain embodiments, Array array0 has a different frame structure than array array1. For example array array0 performs an uplink unicast communication with a mobile station MS2 2512c, while array array1 performs a downlink backhaul communication with cell cell2, array array0 of base station BS 2502b. Base station BS 2502b has a wired backhaul link 2514 to core network 2504.

The wireless link may be broken due to some reasons such as line of sight (LOS) blockage, such as, for example, by moving objects such as people, cars, and the like. That is the wireless link forms a non-line of sight (NLOS) condition that may not have a sufficiently strong ray to maintain communication. Thus, the mobile station MS 2512 may need to switch to a different link even when it is not near the cell edge. Even if the MS is close by a BS and remains relatively stationary, some other object may block the wireless link such that communication is halted. Thus, the MS needs to switch links when its current wireless link cannot be recovered.

If the antenna is not positioned at a high elevation, omni-directional transmit (TX) or receive (RX) beams may be needed. For example, if a particular array is relatively narrow, a wide elevation search, such as 180 degree elevation search may be needed. Conversely, if the antenna is positioned at a high elevation, a less than 180 degree elevation search may be sufficient. Although the present embodiment is described with reference to communications between a base station and a mobile station, other embodiments may also be applicable to communications between two base stations.

In a cell, one or multiple arrays with one or multiple radio-frequency (RF) chains generate beams with different shape for different purposes.

A wide beam 2508 (e.g., a beam typically used for broadcast communication) broadcast beam (BB) are used for synchronization, physical broadcast channel communication, and a physical configuration indication channel that indicates where the physical data control channel is located, and the like. The BB carries the same information for the cell. It has one or multiple BBs in a cell. When there are multiple BBs in a cell, the BBs are differentiated by an implicit or explicit identifier, and the identifier is used by the MS to monitor and report BBs. The BB beams can be swept and repeated. For example, the wide beam 2508 can be one beam with one identifier, or it can be formed by sweeping or steering multiple narrower beams each with a separate identifier. The information on BB beams is repeated depending on the MSs' number of RX beams used to receive the BB beam. In some embodiments, the number of repetitions of the information on BB beams is no less than the number of MSs' number of RX beams to receive BB beam.

Another wide beam is used for some control channels. The BB and the other wide beam may or may not be using the same beamwidth. The BB and the other wide beam may or may not use the same reference signals for the MS to measure and monitor. In certain embodiments, the other wide beam is particularly useful for a broadcast/multicast communication to a group of MSs, as well as some control information for certain MSs, such as MS specific control information, for example, the resource allocation for an MS.

One or multiple beams exist in a cell. When there are multiple beams in a cell, the beams are differentiated by an implicit or explicit identifier, and the identifier is used by the MS to monitor and report the beams. The beams are swept and repeated. The information on the beams are repeated depending on MSs' number of RX beams configured to receive the beams. In some embodiments, the number of repetitions of the information on the beams is no less than the number of MSs' number of RX beams configured to receive the beams. An MS may or may not search for a particular beam by using the information obtained from the broadcast beam BB.

Certain other beams 2510 are used for data communication, and has an adaptive beamwidth. For some MSs, for example, those MSs with low processing speed, a narrower beam is used, while those with higher processing speed, a wider beam is used. Reference signals are transmitted by the other beam. One or multiple base station beams exist in a cell. When there are multiple base station beams in a cell, each base station is differentiated by an implicit or explicit identifier, and the identifier is used by the MS to monitor and report to each specific base station. The beams are repeated. The information on the beams is repeated depending upon MSs' number of RX beams configured to receive each beam. The number of repetitions of the information on the beams is no less than the number of MSs' number of RX beams to receive the beams. A TX beam is locked with a RX beam after the MS monitors the beams, and if the data information is transmitted over a locked RX beam, the repetition of the information on that beam is not needed.

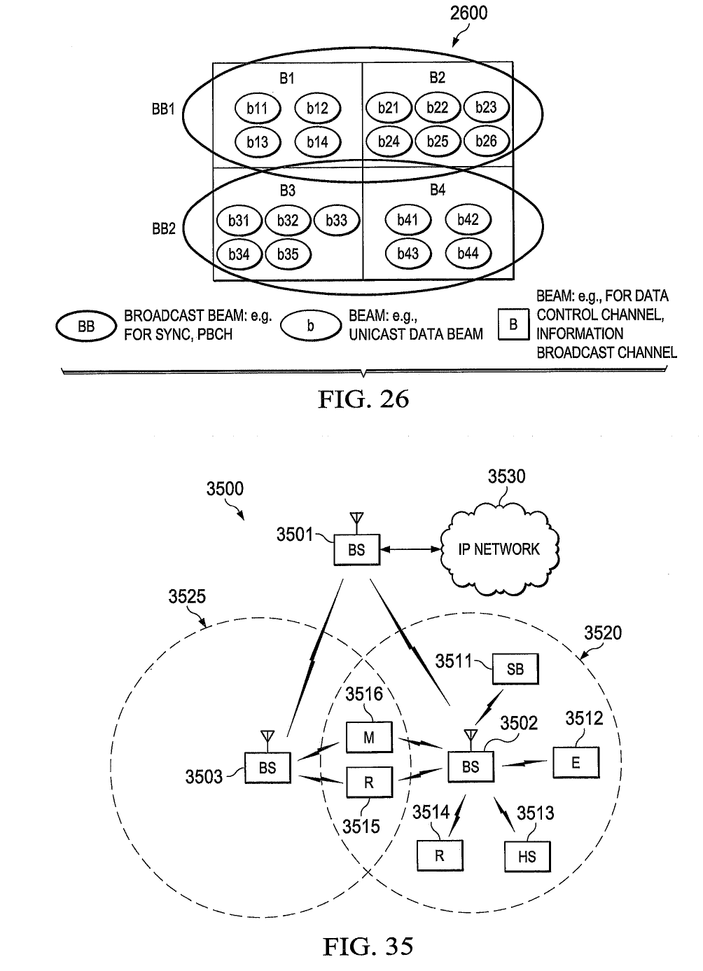

FIG. 26 illustrates an example beam structure according to the teachings of the present disclosure. The embodiment of the beam structure 2600 shown in FIG. 26 is for illustration only. Other embodiments could be used without departing from the scope of this disclosure.

The figure illustrates beams in two dimensions: in azimuth and elevation. For example, the horizontal dimension can represent an azimuthal direction, while the vertical dimension can represent an elevational direction. In a sector, or a cell, one or multiple arrays with one or multiple RF chain can generate beams in different shape for different purposes.

Throughout this document, wireless communication between a BS and another BS as a wireless backhaul communication may be denoted as BS-BS, while wireless communication between a BS and a MS may be denoted as BS-MS.

In certain embodiments, the wireless backhaul communication (e.g., BS-BS) is on different frequency band(s) from the band(s) for access communication (e.g., BS-MS). A frequency band used in a cell is partitioned so that one portion is used for wireless backhaul communication, and another portion is for wireless access. Alternatively, some band(s) is reserved for wireless backhaul communication out of the total available band, while the remaining band(s) are for wireless access. In-between the band for wireless backhaul and the band for access there can be a guard band. When wireless backhaul and wireless access are using different bands, the advantage is that the frame structure and communications for wireless backhaul and wireless access are independent of each other (e.g., they do not need to be differentiated in time domain, or in spatial domain, or in other words, wireless backhaul and wireless access can collide in the time domain, or in the spatial domain), and the interference in-between wireless backhaul and wireless access is not big problem.

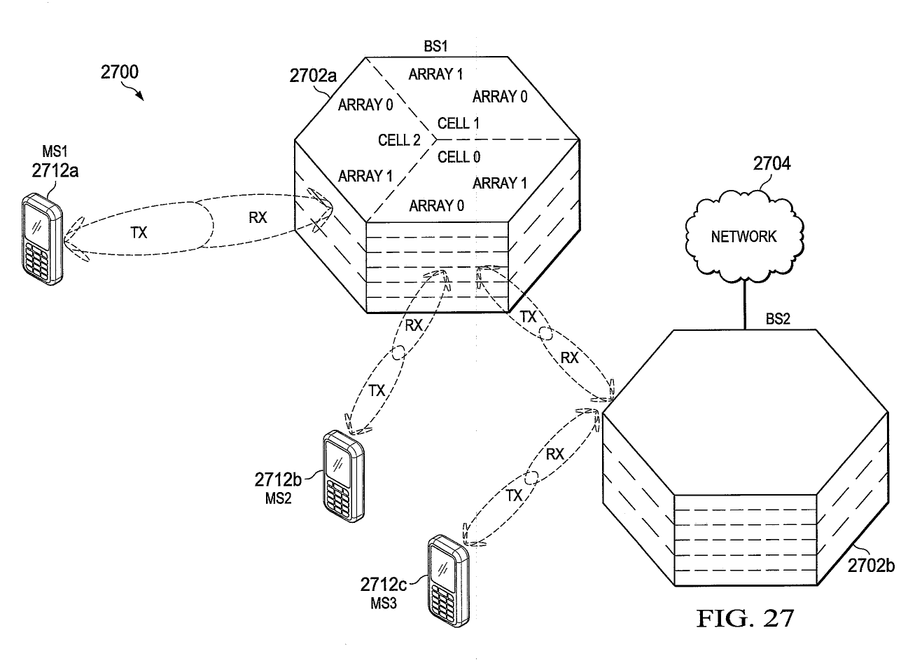

FIG. 27 illustrates another example wireless backhaul communication system 2700 according to the teachings of the present disclosure. The embodiment of the wireless backhaul communication system 2700 shown in FIG. 27 is for illustration only. Other embodiments could be used without departing from the scope of this disclosure.

Wireless backhaul communication system 2700 includes one or more base stations (BSs) 2702 that communicate with a core network 2704 to provide service for one or more MSs. In certain embodiments, spatial division multiplexing (SDM) is used for multiplexing wireless backhaul and wireless access in the same cell. An antenna array forms multiple beams with spatial separation in which one or more beams is used for wireless backhaul while other beams are used for wireless access. The beams for wireless backhaul and the beams for wireless access have a different frame structure in the time domain, that is, they have different uplink/downlink (UL/DL) frame ratio, and/or they have different starting time in either of the UL or DL frame. Some beam(s) formed from an antenna array are transmitting to another BS for wireless backhaul, while some other beam(s) formed from the same antenna array are receiving from an MS in the wireless access.

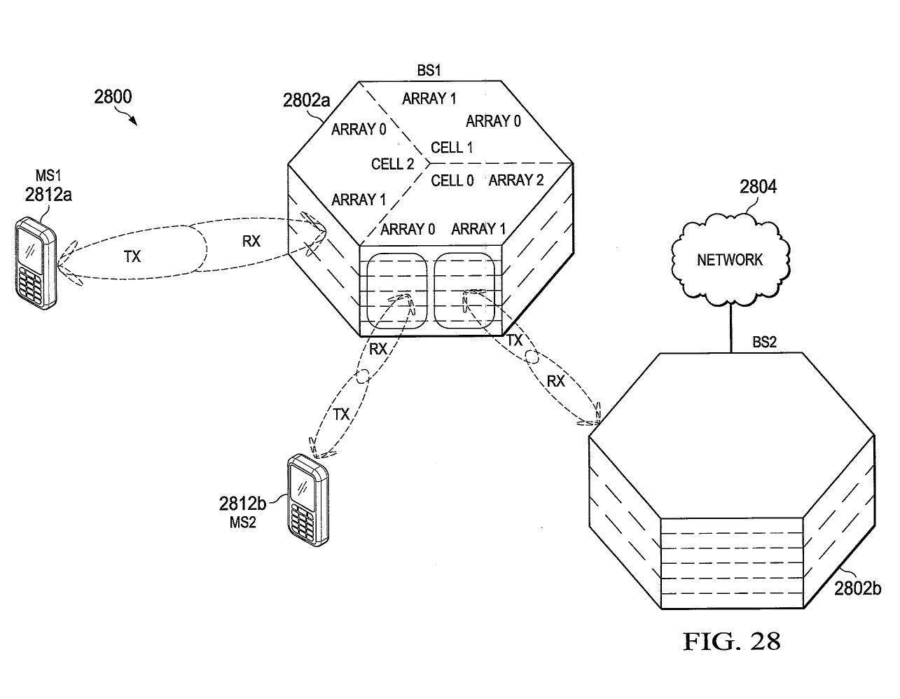

FIG. 28 illustrates another example wireless backhaul communication system 2800 according to the teachings of the present disclosure. The embodiment of the wireless backhaul communication system 2800 shown in FIG. 28 is for illustration only. Other embodiments could be used without departing from the scope of this disclosure.

Wireless backhaul communication system 2800 includes one or more base stations (BSs) 2802 that communicate with a core network 2804 to provide service for one or more MSs. As shown, BS 2802a includes operates with three cells cell0, cell, and cell2.

FIG. 28 shows an example of different subarrays used for wireless access and in-band wireless backhaul, respectively. In the figure, array 0 and array 1 of BS1 Cell 0 are two subarrays configured from the array in a panel facing the same direction, and array 0 has wireless access communication, and array 1 is used for wireless in-band backhaul.

In certain embodiments, an array can form subarrays to form beams, for example, one subarray can be used for wireless backhaul, and the other subarray can be used for wireless access. The configuration of the antenna arrays (e.g., array0, array1, and array2 of Cell0 and array1 of Cell2) are adjustable. For example, an antenna array can have any suitable number of antenna elements. Also, the antenna arrays array0 and array1 form beams with a consecutive or non-consecutive subarray of antenna elements. Additionally, one subarray (e.g. for wireless backhaul) has a different frame structure (e.g., different ratio of DL/UL frames, or different timing for the DL/UL frames) than used by another subarray (e.g., for wireless access).

In certain embodiments, the BS can have multiple arrays, where each array serves as an antenna in a MIMO system. Also, each array can include several subarrays, where the subarrays form a MIMO system. The MIMO resources can be flexibly configured between wireless backhaul and wireless access. For example, a BS with two arrays can configure one array to form a rank-1 link for wireless backhaul, and use the other array to form a concurrent rank-1 link with a user equipment (UE) or a mobile station. Note that UE and mobile station are interchangeable in the disclosure. In another configuration, the BS can use the two arrays to form a rake-2 link for backhaul in one time slot, or it can use the two arrays to form a rank-2 link to a mobile station.

Moreover, the MIMO resources can be flexibly configured between uplink (UL) and downlink (DL). For example, a BS with two arrays can use both to form a rank-2 DL (or, UL) with a UE. Or, can use one array to form a rank-1 DL to one UE and another rank-1 UL to another UE. Moreover, assuming that the array can be used in a fully-duplex mode (i.e., transmit and receive at the same time). The two arrays can be used to form a rank-2 DL to one user and rank-2 UL to another user at the same time. In another configuration, the two arrays can be used to form a rank-1 UL to one UE and a rank-2 DL to another UE. Combination of the technologies can be applied. For example, one subarray can be fully-duplex, while the other can be half duplex. One subarray can be for DL and the other subarray can be for UL.

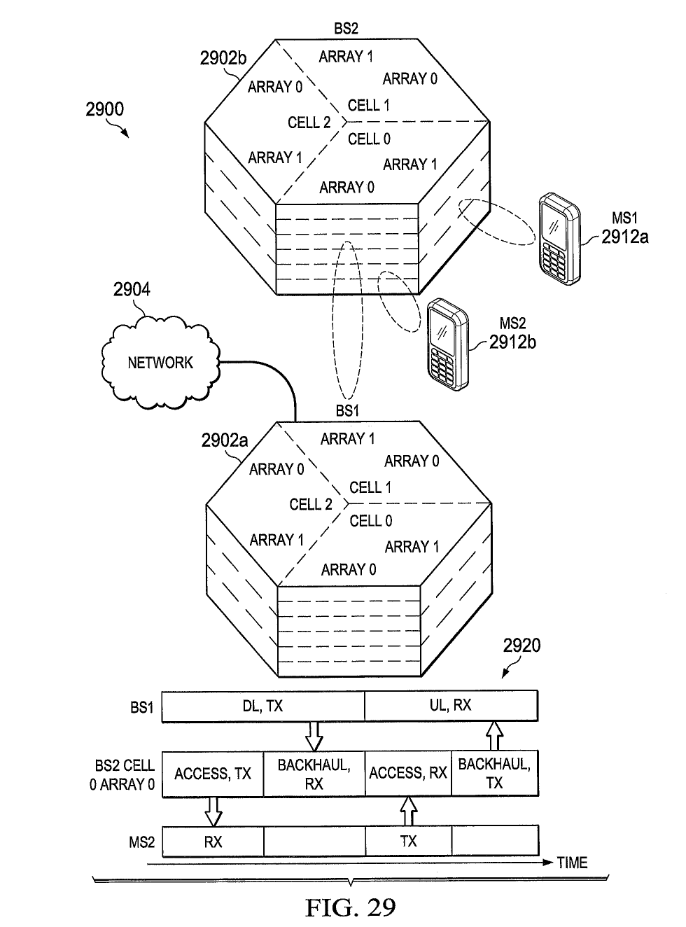

FIG. 29 illustrates an example wireless backhaul communication system 2900 according to the teachings of the present disclosure. The embodiment of the wireless backhaul communication system 2900 shown in FIG. 29 is for illustration only. Other embodiments could be used without departing from the scope of this disclosure.

Wireless backhaul communication system 2900 includes one or more base stations (BSs) 2902a and 2902b that communicate with a core network 2904 to provide service to one or more MSs. As shown, BS 2902a operates with three cells cell0, cell1, and cell2. Each cell includes two arrays array0 and array1 configured to form beams within their respective service regions.

In one embodiment, some resources in the time domain can be reserved for wireless backhaul communications. In order to mitigate possible interference, a frame structure where the access and the wireless backhaul communications share the time domain resources can be used. For example, the cell who will use the same antenna array(s) to communicate with another cell as well as an MS, can use time division multiplexing for its backhaul communication with another cell and wireless access communication with MS. The particular communication system 2900 as shown provides an example of a time division multiplexing of wireless access and in-band wireless backhaul. BS2 2902b does not have a wired backhaul. Therefore, it may communicate with another BS to establish communication with the network 2904. BS2 2902b can get to the network via BS1 2902a, which has a wired link with the network.

Cell cell0 of BS2 2902b communicates with BS1 2902a. As a cell which typically would serve mobile stations, Cell cell0 communicates with MS2 2912b. The frame structure 2914 in the time domain can be as shown. BS2 2902b Cell cell0 has an access link with MS2 2912b and a backhaul communication with BS1 2902a are orthogonal in the time domain. Other types of communication links may be possible. For example, the order of the TX beam and RX beam for BS2 2902b cell cell0 can be different than what is shown; for example, the order can be: backhaul RX beam, access TX beam, backhaul TX beam, access RX beam, and MS2 RX beam and TX beam, which can be changed accordingly. In the figure, DL is downlink, UL is uplink, TX is transmission, RX is receiving.

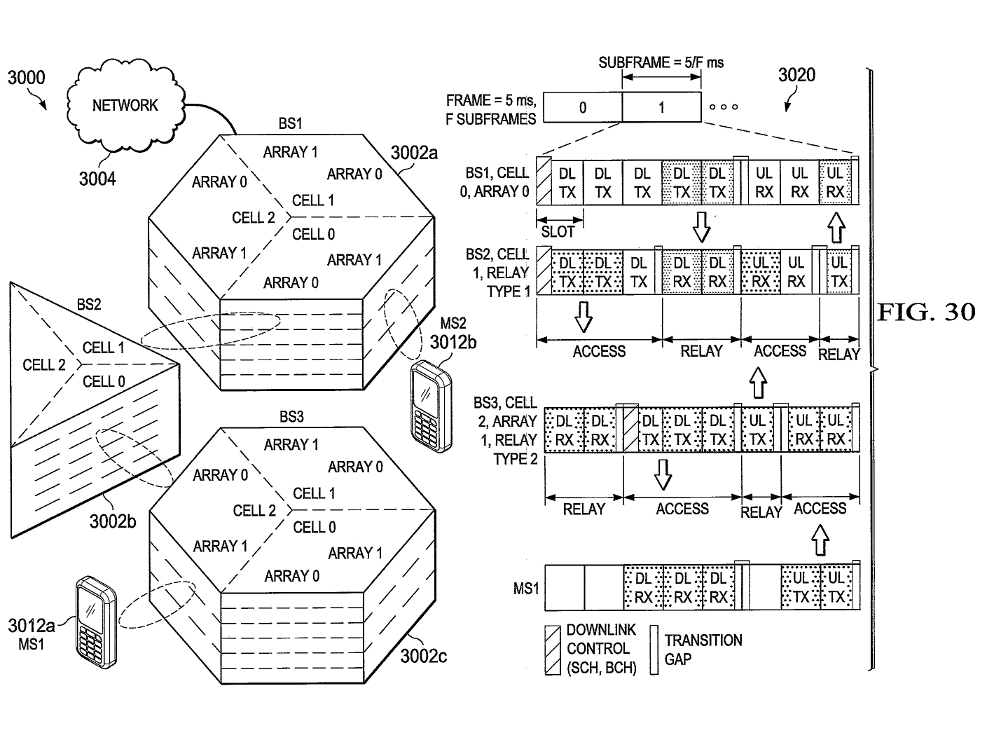

FIG. 30 illustrates an example wireless backhaul communication system 3000 and a frame structure 3020 according to the teachings of the present disclosure. The embodiment of the wireless backhaul communication system 3000 shown in FIG. 30 is for illustration only. Other embodiments could be used without departing from the scope of this disclosure.

Wireless backhaul communication system 3000 includes multiple base stations (BSs) 3002a, 3002b, and 3002c that provide communication of a MS 3012 with a core network 3004. As will be described in detail below, a BS can serve as a node to help other BSs to obtain access to the network using different types of frame structures in the time domain, based on the previous node and next node along the path that the base station who needs wireless backhaul gets to the network.

A relay type 1 may be one in which the cell has DL access first, followed by DL RX for the backhaul link, UL RX for access, UL TX for the backhaul link, in the same time duration of a regular base station DL TX and UL RX. This allows some of the control channels, such as synchronization or broadcast channel to be aligned with the regular base station. A relay type 2 may be another one in which the cell has DL RX, DL TX, UL TX, and UL RX, in the same time duration of the BS's DL TX and UL RX.

The relay type 1 and relay type 2 can alternate for BSs along the path that the base station that needs wireless backhaul may obtain access to the network.

As shown, relay type1 means that the cell has DL access first, followed by DL RX for the backhaul link, UL RX for access, UL TX for the backhaul link in the same time duration of the BS's DL TX and UL RX. This can provide at least some of the control channels, such as synchronization or broadcast channel to be aligned with the BS. Relay type2 means that the cell has DL RX, DL TX, UL TX, and UL RX, in the same time duration of the BS's DL TX and UL RX.

BS2 uses a type 1 frame structure, while BS3 uses a type 2 frame structure. For the type 1 frame structure, some of the control channels, such as downlink synchronization, broadcast channels, can be aligned with the BS, which has a wired backhaul link, in the time domain, while the type 2 frame structure may not provide such an alignment.

To reduce the interference, some of the resources in the subframe may not have any activities such as RX or TX. The transition gap is provided for transitions of UL to DL or DL to UL, and TX to RX or RX to TX.

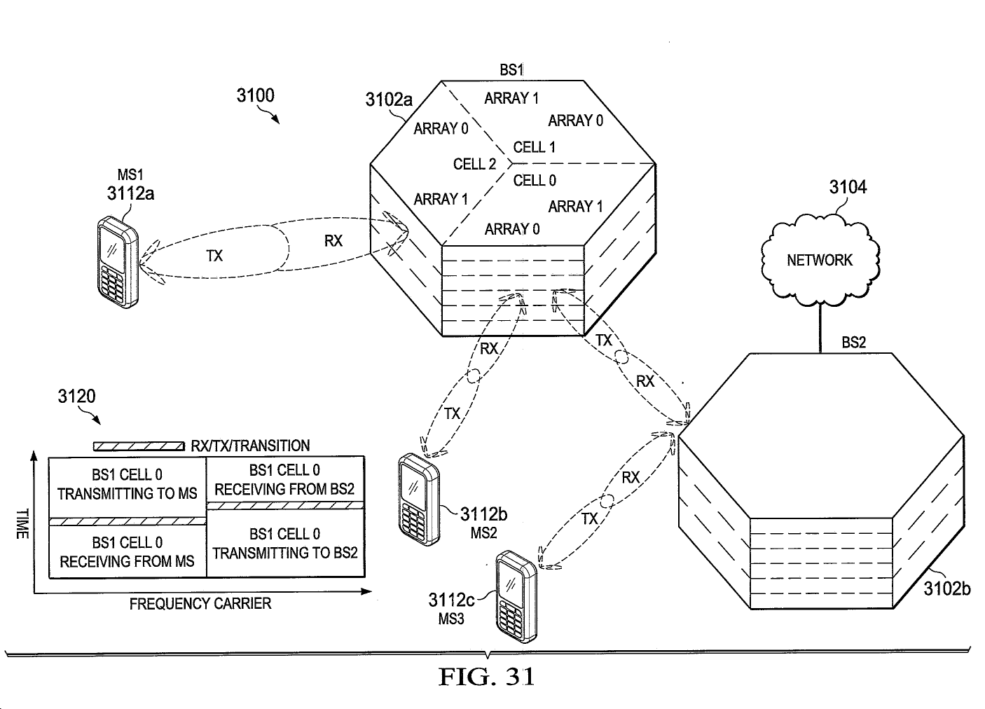

FIG. 31 illustrates an example wireless backhaul communication system 3100 and a frame structure 3120 showing an example of multiplexing wireless access and wireless in-band backhaul in the spatial domain, as well as in the frequency subcarrier domain according to the teachings of the present disclosure. The embodiment of the wireless backhaul communication system 3100 shown in FIG. 31 is for illustration only. Other embodiments could be used without departing from the scope of this disclosure.

Wireless backhaul communication system 3100 includes base stations (BSs) 3002a and 3102b that provide service to multiple MS 3012. As will be described in detail below, frequency subcarriers can be partitioned so that some of the subcarriers can be for wireless backhaul and others can be for wireless access. Additionally, between the subcarriers for wireless backhaul and wireless access, a guard band may, or may not be used. The subcarrier level of frequency division multiplexing can be combined with spatial division multiplexing, especially when no guard band is desired.

The beams on the frequency subcarriers assigned for wireless backhaul links can have different frame structures (e.g., different ratio of DL/UL, different timing for DL or UL, and the like) than some other beams on the frequency subcarriers for wireless access.

The partition of the subcarriers for wireless backhaul and wireless access can be flexible and configurable based on the system's need. For example, when there is more traffic on the wireless backhaul link than the access link, more subcarriers can be assigned to wireless backhaul; however, when no wireless backhaul link is needed or the traffic over the wireless backhaul is limited, such as when the wireless backhaul only maintains the link with no active traffic, most or all the subcarriers can be for the wireless access.

The configuration and its update of the subcarrier assignment for the wireless backhaul link or the wireless access link can be sent to the mobile stations and base stations, for example, via broadcast channel, broadcast messages, multicast, unicast, and the like. The update of the configuration and the timing of the update of the configuration can be sent before the actual change, so that the MSs and BSs can know the change beforehand and get prepared for the change, and switch to the new frequency carriers at the time that the update of the configuration becomes effective.

As shown, wireless access between BS1 3102a Cell cell1 and MS2 3112b, and the wireless in-band backhaul between BS1 3102a and BS2 3102b, are separated in the spatial domain, by using different beams pointed in different directions. These two communications can be separated in the domain of frequency carrier domain as well to further reduce the interference in-between the beams for these two communication links.

In one embodiment, a combination of technologies in the present disclosure can be applied. For example, wireless access and wireless in-band backhaul can be multiplexed in the spatial domain, as well as in the time domain.

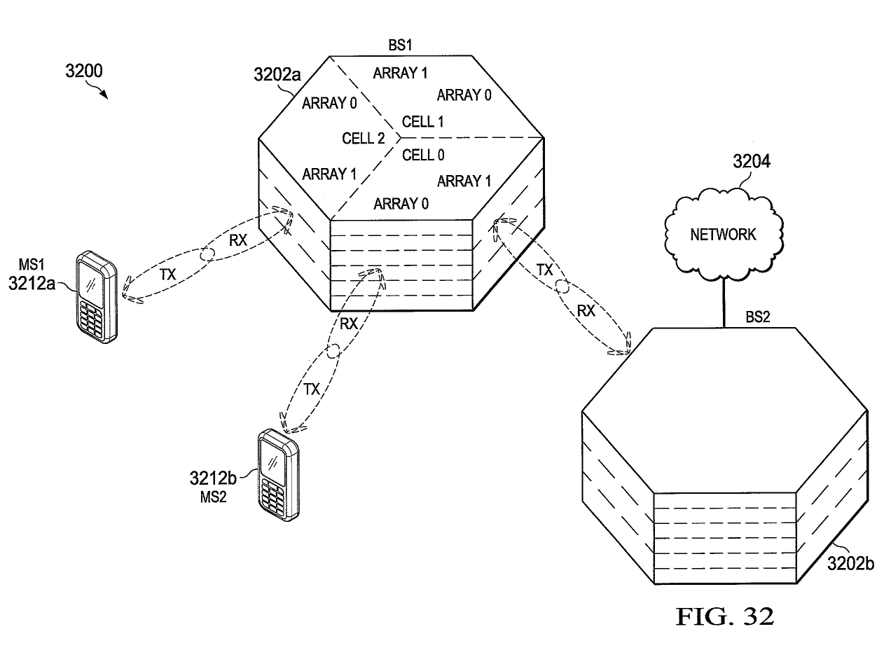

FIG. 32 illustrates an example wireless backhaul communication system 3200 showing different arrays facing different directions used for multiplexing wireless access and wireless in-band backhaul according to the teachings of the present disclosure.

The embodiment of the wireless backhaul communication system 3200 shown in FIG. 32 is for illustration only. Other embodiments could be used without departing from the scope of this disclosure.

Wireless backhaul communication system 3200 includes base stations (BSs) 3202a and 3202b that provide communication of multiple MS 3212 to a core network 2304. As will be described in detail below, different arrays can be used to multiplex the wireless backhaul and wireless access. For example, one array can be for the wireless backhaul, and another array can be for the wireless access link.

Arrays facing different directions can be used to multiplex the wireless backhaul and wireless access links. For example, an array facing in a first direction can be used for the wireless backhaul link, and another array facing in a second direction can be for the wireless access link.

In certain situations, it may be difficult to mitigate interference if two arrays for a BS-BS link and a BS-MS link are pointed in the same direction. However, when they face different directions, techniques can be used to mitigate the interferences. The interference between arrays facing different directions can be mitigated, for example, by using reflectors at the back of the arrays, using certain type of materials and physical application of those materials, using nulling in steering of the beams, and the like.

Multiple arrays can exist in a cell. Each array in a cell may have the same or a different synchronization channel and broadcast channel. Some arrays (e.g. for wireless backhauling) can have a different frame structure (e.g., different ratio of DL/UL, different timing for DL or UL) than the other arrays in the same cell. The resources including arrays and antennas for wireless backhaul can be flexibly configured. For example, when a wireless backhaul link is needed, some array(s) or antennas can be assigned to wireless backhaul communications. However, when no wireless backhaul communication is needed, the arrays or antennas assigned to the wireless backhaul link can be added to an available pool of existing arrays or antennas for wireless access in other communication links.

In one embodiment, mechanical adjustment of the direction of the array can be applied so that the direction of the array can be adjusted or flexibly changed. For example, when a wireless backhaul link is needed, the direction of some array(s) can be physically steered so that interference can be mitigated between backhaul communications and wireless access.

When no wireless backhaul communication is needed, the direction of the arrays for wireless backhaul can be steered back to their original direction such that the arrays can be added to the available pool of existing arrays for wireless access. This may enhance the performance of the wireless access due to increased number of antennas.

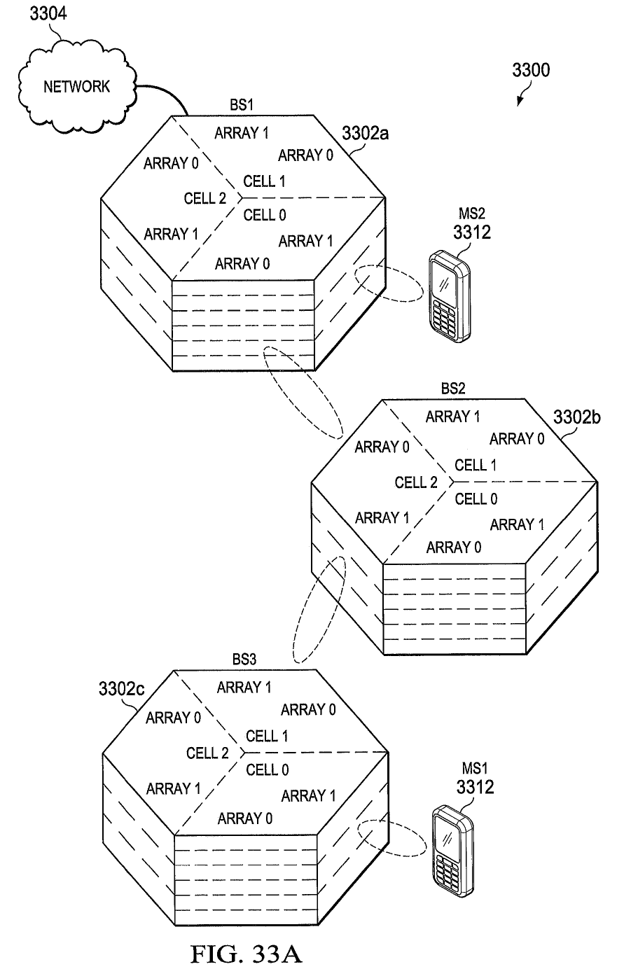

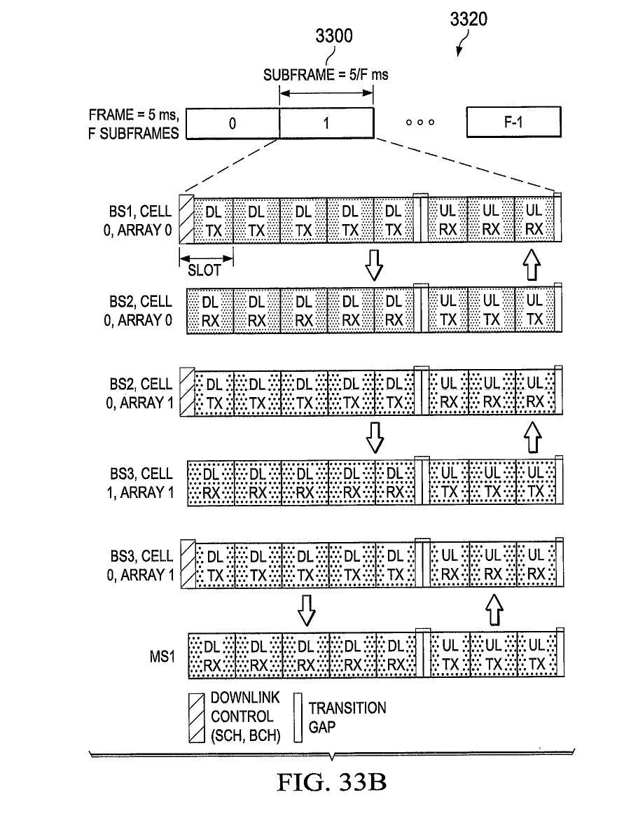

FIG. 33 illustrates an example wireless backhaul communication system 3300 and an associated frame structure 3320 showing an example of multi-hop wireless in-band backhaul by using arrays facing different directions from the arrays for wireless access according to the teachings of the present disclosure. The embodiment of the wireless backhaul communication system 3300 shown in FIG. 33 is for illustration only. Other embodiments could be used without departing from the scope of this disclosure.

Wireless backhaul communication system 3300 includes base stations (BSs) 3302a, 3302b, and 3302c that provide communication of multiple MS 3312 to a core network 3304. As will be described in detail below, a cell can use two different antenna arrays to conduct wireless backhaul communication and wireless access communication. Multiple different arrays of a BS can also be used for wireless backhaul communications with multiple other BSs.

Based on the network topology, if wireless backhaul is needed, then some array on the BS without wired backhaul can be dedicated for wireless backhaul, that is, no MSs would be associated with the wireless backhaul.

Some of the arrays or antennas of a cell can function like a base station to serve mobile stations for wireless access or other base stations for wireless backhaul, while some of the arrays or antennas of a cell can function like an MS when they need to have wireless backhaul communications with other BS. By using such, adaptive wireless backhauling can be achieved without using the relay type of frame structure in the time domain.

As shown, BS2 3302b does not have a wired backhaul link, hence BS2 3302b needs to find a path to get to the network 3304. BS2 3302b discovers BS1 3302a. BS1 3302a has a connection with the network 3304, hence BS2 3302b requests BS1 3302a to provide wireless backhaul service so that it can access the network. In this regard, BS1 3302a assigns cell cell0 array array0 to support the wireless backhaul link (BS1 3302a cell cell0 array array0 can support wireless access), while cell cell0 array array1 keeps serving the wireless access. BS2 3302b assigns cell cell2 array array0 to provide the wireless backhaul with BS1 3302a cell cell0 array array0 BS2 3302b cell cell2 array array0 can function like an MS, communicating with BS1 3302a cell cell0 array array0.

Similarly, BS3 3302c can establish a wireless backhaul link with BS2 3302b. BS3 3302c cell cell array array1 can function like an MS, communicating with BS2 3302b cell cell2 array array1 that functions like a BS.

In certain embodiments, if the wireless backhaul and wireless access links are sharing a common pool of the arrays, identification is used for indicating whether the beams are used for wireless backhaul or not. Both MSs should know these identifiers. That is, a MS should not try to lock to the beams used for BS-BS links, and a BS should not try to lock to the beams for MS-BS links. Explicit and implicit identifications are used to differentiate wireless backhaul (BS-BS) links and wireless access (BS-MS) links.

The identification is, for example, implicitly carried in a synchronization channel. The preambles of the synchronization channel or the physical cell IDs are partitioned so that one set of the physical cell ID can be for the wireless backhaul communications. The receiver knows the partitions as well, so that the receiver recognizes whether the received synchronization signal is for wireless backhaul or not.

The identifications are indicated, for example, by array identifiers: if some array is for BS-BS links, some unique identifier is used. Some array identifiers are explicitly included in the broadcast channel. The array identifier is implicitly carried, for example, by scrambling the CRC of the broadcast channel.

The identification is indicated, for example, by beam identifiers: certain reserved beam identifiers are used for BS-BS links. Some antenna identifiers are explicitly included in the broadcast channel. The antenna identifier is implicitly carried, for example, by scrambling the CRC of the broadcast channel.

In certain embodiments, the resource allocation for in-band wireless backhauling can be based on need. For example, a BS may not have wireless backhaul services ON if there is no need for the neighboring BS, that is, the neighboring BSs that may need wireless backhauling are OFF. This may occur, for example, due to a low load, day time around a residential district, or at night time around an office environment.

A BS can have wireless backhaul services ON when the neighboring BSs that need wireless backhauling are ON (e.g., due to a heavy load, hot zone and the like). The ratio of resources for BS-BS links and BS-MS links are flexible. For example, BS-BS links use approximately from approximately 0 to 100 percent of the total resources. This is achieved by, for example, using spatial division multiplexing combining subcarrier partitioning. BS-BS links are separated from BS-MS links along spatial directions. In addition, some frequency carriers are for BS-BS links and other carriers for BS-MS links, where no guardband is needed for subcarrier partitioning. Alternatively, this is achieved by, for example, flexible UL/DL ratio in the time domain.

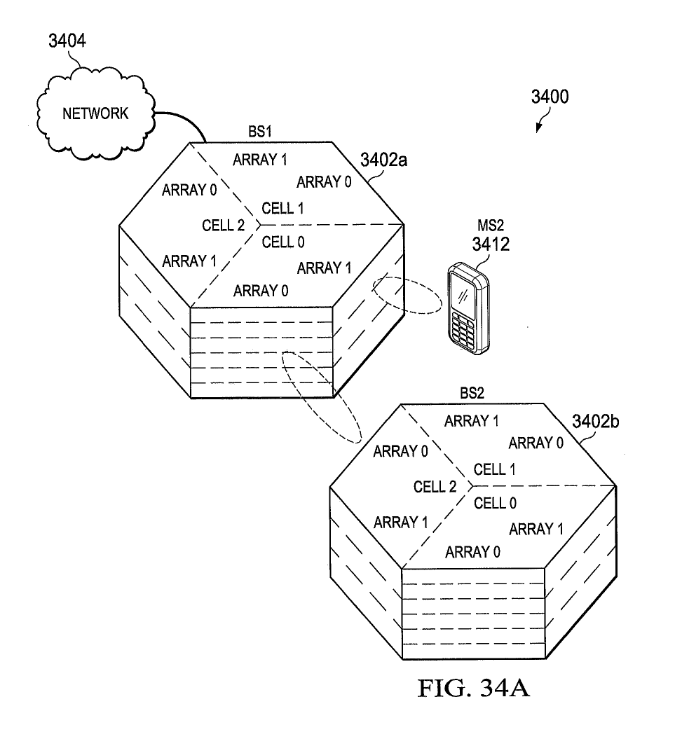

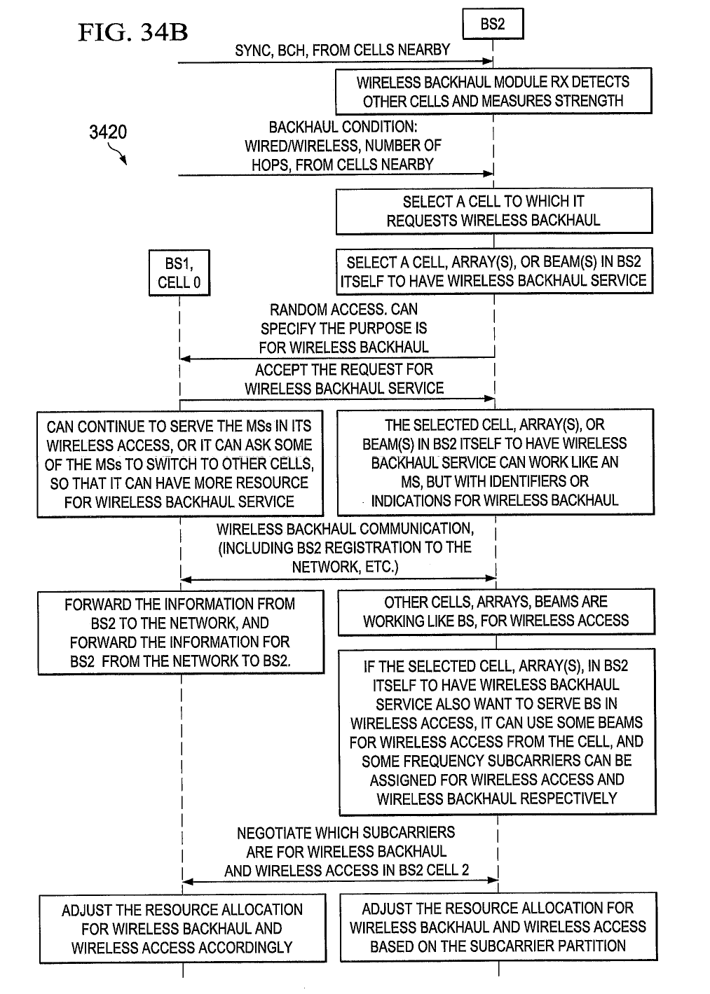

FIG. 34 illustrates an example wireless backhaul communication system 3400 and an associated call flow diagram 3420 showing a BS that can assign certain antennas, subarrays, or arrays in one or more cells to function like an MS, while providing backhaul communication according to the teachings of the present disclosure. The embodiment of the wireless backhaul communication system 3400 shown in FIG. 34 is for illustration only. Other embodiments could be used without departing from the scope of this disclosure.

Wireless backhaul communication system 3400 includes base stations (BSs) 3402a and 3402b that provide access for a MS 3412. The BS1 3402a may incorporate a module for establishing wireless backhaul links with other BSs using one of two alternatives. In one alternative, for the BS1 3402a that needs to have wireless backhaul (e.g., due to lack of access to wired backhaul), certain antenna arrays may function like an MS, but with some identifier saying that it is for backhaul communication, and other antenna arrays still serve as a BS to provide wireless access while the other BS that the BS needing wireless backhaul would have wireless backhaul link with, can still function like a BS. In another alternative, for the BS that needs to have wireless backhaul (e.g., due to lack of access to wired backhaul), the module for the wireless backhaul can function like a BS while the other BS that the BS needing wireless backhaul would have wireless backhaul link with, assigns some antenna arrays in some cell to function like an MS, but with some identifier saying that it is for backhaul communication.

The two alternatives described above are switched based on the network's need and interference mitigation capability and requirements, network load, and the like. For example, the BS can start with the first alternative for initialization, and later on, use the second alternative, where before such a switch, the network or BS should get prepared, and signaling including the new switch and timing can be sent to the BSs.

An example procedure for the first alternative is as follows. The procedure for the second alternative is similarly adapted.

The BS1 3402a serves wireless access for MS2 3412 and it has connectivity to the network. BS2 3402b does not have a wired connection with the network, hence it needs to establish a wireless backhaul through another BS to access the network. The BS2 3402b scans nearby BSs, for example, by scanning the synchronization channel, and broadcast channel. The BS2 3402b also performs estimation of nearby cells or BSs. Nearby BSs broadcast their backhaul connections, for example, whether the backhaul connections are wired or wireless, or mixed, or how many hops to get to the network, how many hops are wireless or wired, and the like. The BS2 3402b then selects a cell to which it would ask for wireless backhaul communications. The BS2 3402b also chooses which cell, array(s) or beam(s) to use in the BS2 3402b itself for the wireless backhaul communication.

The chosen cell, array(s) or beam(s) start the random access procedure with a chosen cell in the BS1 3402a. In the random access procedure, the BS2 3402b can tell the BS1 3402a that it is for wireless backhaul. They establish the wireless backhaul links for communication. The BS1 3402a forwards the information from the BS2 3402b to the network, and forwards the information for the BS2 3402b from the network to the BS2 3402b. In the BS2 3402b, other cells, arrays, beams function like BS, for wireless access. In certain embodiments, the BS2 3402b is registered to the network, and authentication and authorization, and the like can be done.

If the selected cell, array(s), in the BS23 3402b also wants to serve the BS1 3402a to provide wireless access, it uses some beams for wireless access from the cell, and some frequency subcarriers are assigned for wireless access and wireless backhaul, respectively. The BS2 3402b negotiates with the network or the BS1 3402a about which subcarriers are for wireless backhaul and wireless access in the BS2 3402b. After the subcarriers partition is decided, both BS1 and BS2 adjust the resource allocation for wireless backhaul and wireless access based on the subcarrier partition.

The first alternative described above, which includes a wireless backhaul module in the BS that provides wireless backhaul, assigns certain antenna arrays in certain cells to function like an MS, but with some identifier indicating that it is for backhaul communication, while the other BS that the BS providing the wireless backhaul would have a wireless backhaul link with, functions like a BS.

The BS1 3402a serves wireless access for MSs and it has connectivity to the network. The BS2 3402b does not have a wired connection with the network, hence it may establish a wireless backhaul with another BS so that it can access the network. The BS2 3402b scans nearby BSs, for example, by scanning the synchronization channel, and broadcast channel. The BS2 3402b also performs estimation of the nearby cells or BSs. Nearby BSs broadcasts their backhaul conditions, for example, whether it is wired, wireless, mixed, how many hops to get to the network, how many hops are wireless or wired, and the like. The BS2 3402b then selects a cell to which it would request access to wireless backhaul communications. The BS2 3402b also chooses which cell, array(s) or beam(s) to use in the BS2 3402b for the wireless backhaul link.

The BS2 3402b chooses BS1 cell0 to request access to wireless backhaul service. The BS2 3402b chooses the first array of the third cell to be used for wireless backhaul service. The first array of the third cell of the BS2 3402b initiates a random access procedure with the first cell of the BS1 3402a. In the random access procedure, the third cell of the BS2 3402b tells the first cell of the BS1 3402a that it is for wireless backhaul. Both establish wireless backhaul links. The BS1 3402a forwards the information from the BS2 3402b to the network, and forwards the information for the BS2 3402b from the network to the 3402b. In the BS2 3402b, other cells, arrays, and/or beams function like a BS to provide wireless access. The BS2 3402b is registered to the network and authentication, authorization, and the like can be performed.

If the selected cell, array(s), in the BS2 3402b also want to serve the BS in wireless access, it uses some beams for wireless access from the cell, and some frequency subcarriers are assigned for wireless access and wireless backhaul, respectively. The BS2 3402b negotiates with the network or the BS1 3402a about which subcarriers are for wireless backhaul.

For initial establishment, the second alternative is similar to that of the first alternative. After the wireless backhaul is established, it can also be changed to the second alternative. The BS2 3402b establishes wireless backhaul with the BS1 3402a using the first alternative 1 approach. Next, the role of the first array of the first cell of the BS1 3402a and the first array of the third cell of the BS2 3402b can be swapped, that is, making the first array of the first cell of the BS1 3402a function like a MS, while the first array of the third cell of the BS2 3402b functions as a BS. The first array of the first cell of the BS1 3402a is assigned to work like a MS, to serve the wireless backhaul, while all the other arrays in the BS1 3402a can function as the regular BS to serve the wireless access. Before the switch to the second alternative, the network or the BSs communicate the change with each other so that all the wireless backhaul related elements can get prepared for such a change and know what to do with the change.

FIG. 35 illustrates an example wireless network 3500, which performs the various embodiments above according to the principles of the present disclosure. The embodiment of the wireless network 3500 shown in FIG. 35 is for illustration only. Other embodiments could be used without departing from the scope of this disclosure.

In the illustrated embodiment, wireless network 3500 includes base station (BS) 3501, base station (BS) 3502, base station (BS) 3503, and other similar base stations (not shown). Base station 3501 is in communication with base station 3502 and base station 3503. Base station 3501 is also in communication with Internet 3530 or a similar IP-based network (not shown).

Base station 3502 provides wireless broadband access (via base station 3501) to Internet 3530 to a first plurality of mobile stations within coverage area 3520 of base station 3502. The first plurality of mobile stations includes mobile station 3511, which can be located in a small business (SB), mobile station 3512, which can be located in an enterprise (E), mobile station 3513, which can be located in a WiFi hotspot (HS), mobile station 3514, which can be located in a first residence (R), mobile station 3515, which can be located in a second residence (R), and mobile station 3516, which can be a mobile device (M), such as a cell phone, a wireless laptop, a wireless PDA, or the like.

Base station 3503 provides wireless broadband access (via base station 3501) to Internet 3530 to a second plurality of mobile stations within coverage area 3525 of base station 3503. The second plurality of mobile stations includes mobile station 3515 and mobile station 3516. In an exemplary embodiment, base stations 3501-3503 may communicate with each other and with mobile stations 3511-3516 using OFDM or OFDMA techniques.

Base station 3501 is in communication with either a greater number or a lesser number of base stations. Furthermore, while only six mobile stations are depicted in FIG. 35, it is understood that wireless network 3500 can provide wireless broadband access to additional mobile stations. It is noted that mobile station 3515 and mobile station 3516 are located on the edges of both coverage area 3520 and coverage area 3525. Mobile station 3515 and mobile station 3516 each communicate with both base station 3502 and base station 3503 and can be said to be operating in handoff mode, as known to those of skill in the art.

Mobile stations 3511-3516 may access voice, data, video, video conferencing, and/or other broadband services via Internet 3530. In an exemplary embodiment, one or more of mobile stations 3511-3516 may be associated with an access point (AP) of a WiFi WLAN. Mobile station 3516 may be any of a number of mobile devices, including a wireless-enabled laptop computer, personal data assistant, notebook, handheld device, or other wireless-enabled device. Mobile stations 3514 and 3515 may be, for example, a wireless-enabled personal computer (PC), a laptop computer, a gateway, or another device.

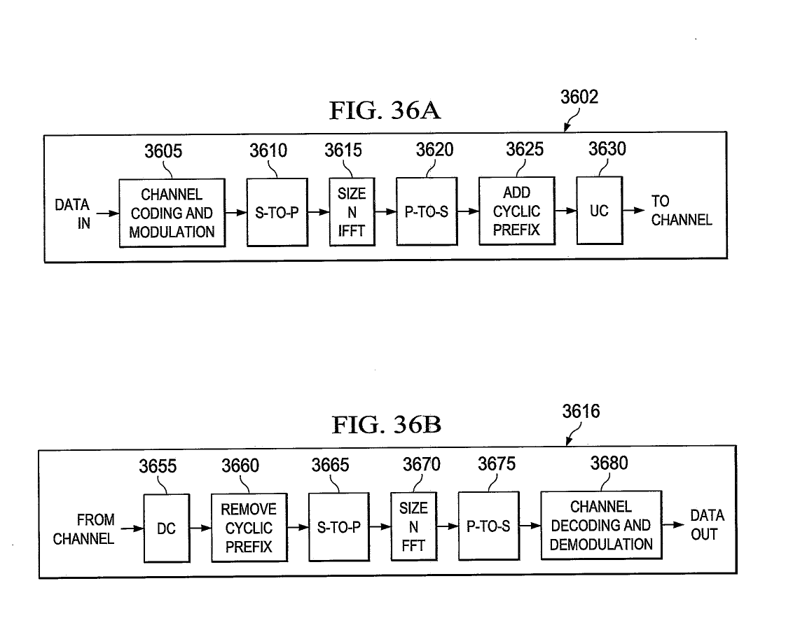

FIG. 36A is a high-level diagram of an orthogonal frequency division multiple access (OFDMA) transmit path. FIG. 36B is a high-level diagram of an orthogonal frequency division multiple access (OFDMA) receive path. In FIGS. 36A and 36B, the OFDMA transmit path is implemented in base station (BS) 3502 and the OFDMA receive path is implemented in mobile station (MS) 3516 for the purposes of illustration and explanation only. However, it will be understood by those skilled in the art that the OFDMA receive path may also be implemented in BS 3502 and the OFDMA transmit path may be implemented in MS 3516.

The transmit path in BS 3502 comprises channel coding and modulation block 3605, serial-to-parallel (S-to-P) block 3610, Size N Inverse Fast Fourier Transform (IFFT) block 3615, parallel-to-serial (P-to-S) block 3620, add cyclic prefix block 3625, up-converter (UC) 3630. The receive path in MS 3516 comprises down-converter (DC) 3655, remove cyclic prefix block 3660, serial-to-parallel (S-to-P) block 3665, Size N Fast Fourier Transform (FFT) block 3670, parallel-to-serial (P-to-S) block 3675, channel decoding and demodulation block 3680.

At least some of the components in FIGS. 36A and 36B may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

In BS 3502, channel coding and modulation block 3605 receives a set of information bits, applies LDPC coding and modulates (e.g., QPSK, QAM) the input bits to produce a sequence of frequency-domain modulation symbols. Serial-to-parallel block 3610 converts (i.e., de-multiplexes) the serial modulated symbols to parallel data to produce N parallel symbol streams where N is the IFFT/FFT size used in BS 3502 and MS 3516. Size N IFFT block 3615 then performs an IFFT operation on the N parallel symbol streams to produce time-domain output signals. Parallel-to-serial block 3620 converts (i.e., multiplexes) the parallel time-domain output symbols from Size N IFFT block 3615 to produce a serial time-domain signal. Add cyclic prefix block 3625 then inserts a cyclic prefix to the time-domain signal. Finally, up-converter 3630 modulates (i.e., up-converts) the output of add cyclic prefix block 3625 to RF frequency for transmission via a wireless channel. The signal may also be filtered at baseband before conversion to RF frequency.

The transmitted RF signal arrives at MS 3516 after passing through the wireless channel and reverse operations to those at BS 3502 are performed. Down-converter 3655 down-converts the received signal to baseband frequency and remove cyclic prefix block 3660 removes the cyclic prefix to produce the serial time-domain baseband signal. Serial-to-parallel block 3665 converts the time-domain baseband signal to parallel time domain signals. Size N FFT block 3670 then performs an FFT algorithm to produce N parallel frequency-domain signals. Parallel-to-serial block 3675 converts the parallel frequency-domain signals to a sequence of modulated data symbols. Channel decoding and demodulation block 3680 demodulates and then decodes (i.e., performs LDPC decoding) the modulated symbols to recover the original input data stream.

Each of base stations 3501-3503 may implement a transmit path that is analogous to transmitting in the downlink to mobile stations 3511-3516 and may implement a receive path that is analogous to receiving in the uplink from mobile stations 3511-3516. Similarly, each one of mobile stations 3511-3516 may implement a transmit path corresponding to the architecture for transmitting in the uplink to base stations 3501-3503 and may implement a receive path corresponding to the architecture for receiving in the downlink from base stations 3501-3503.

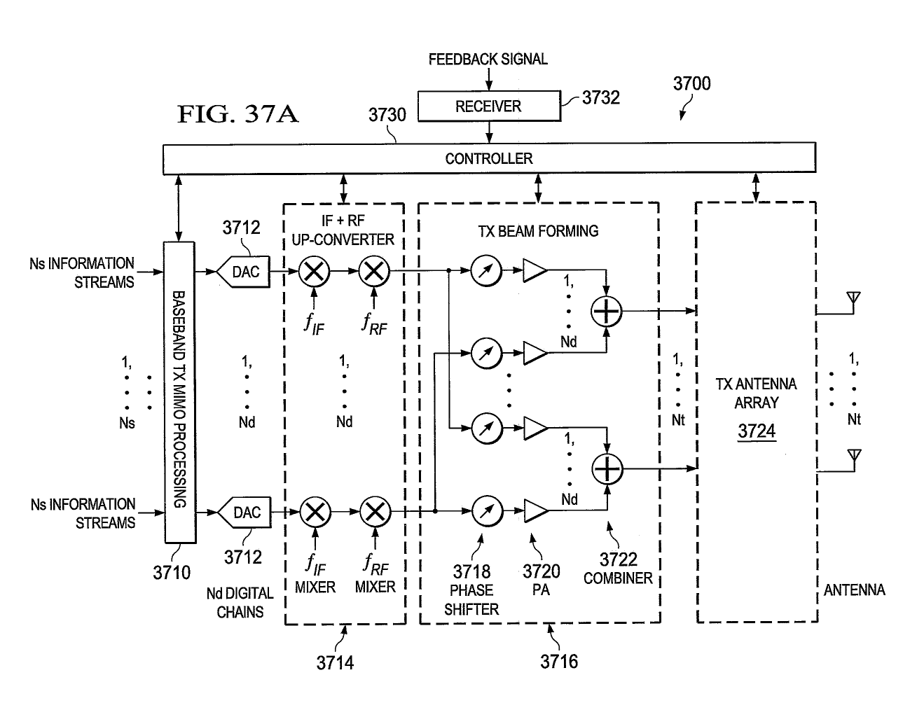

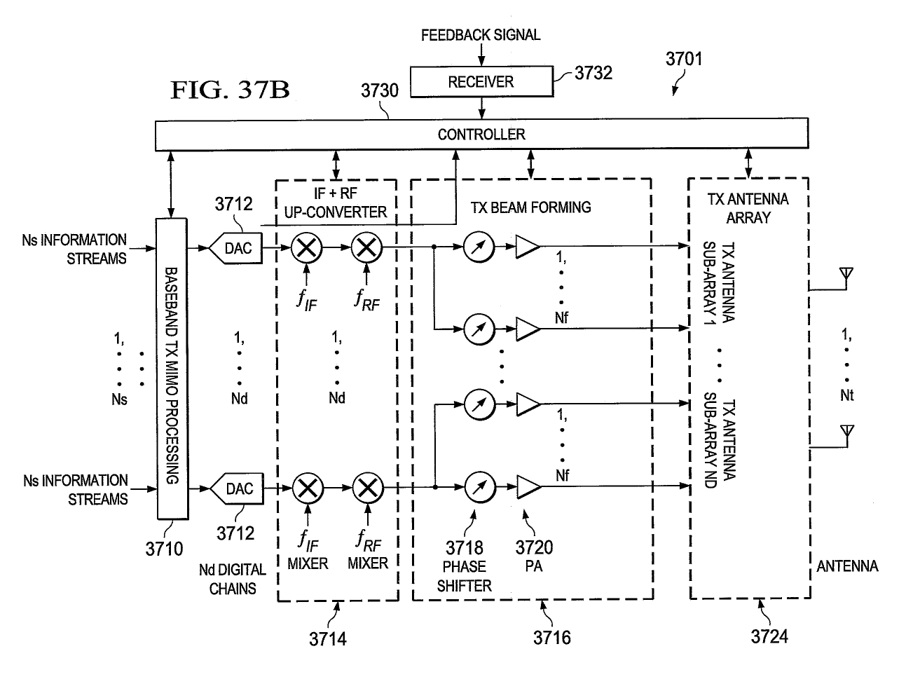

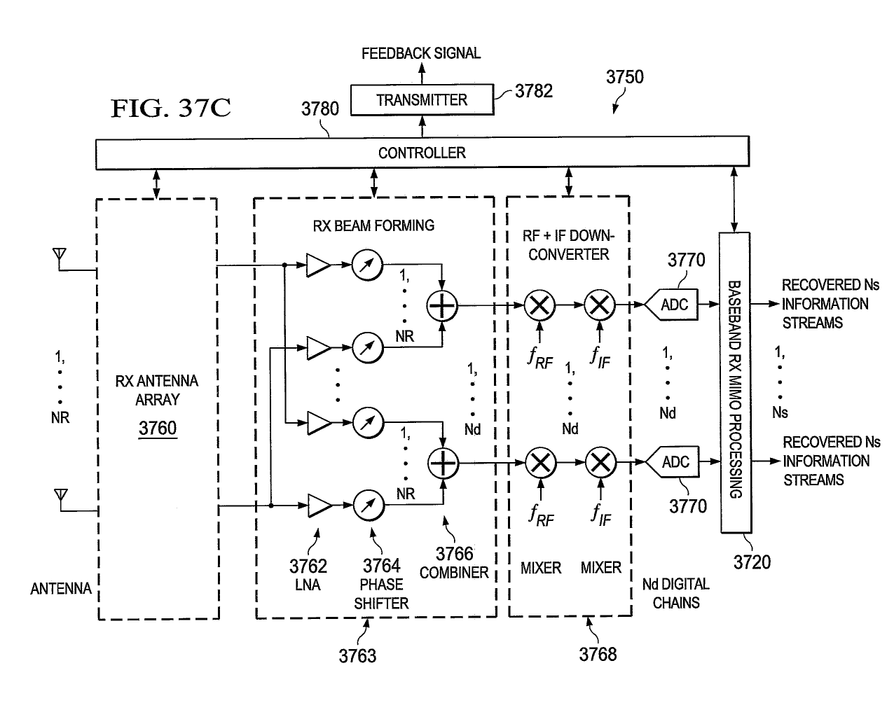

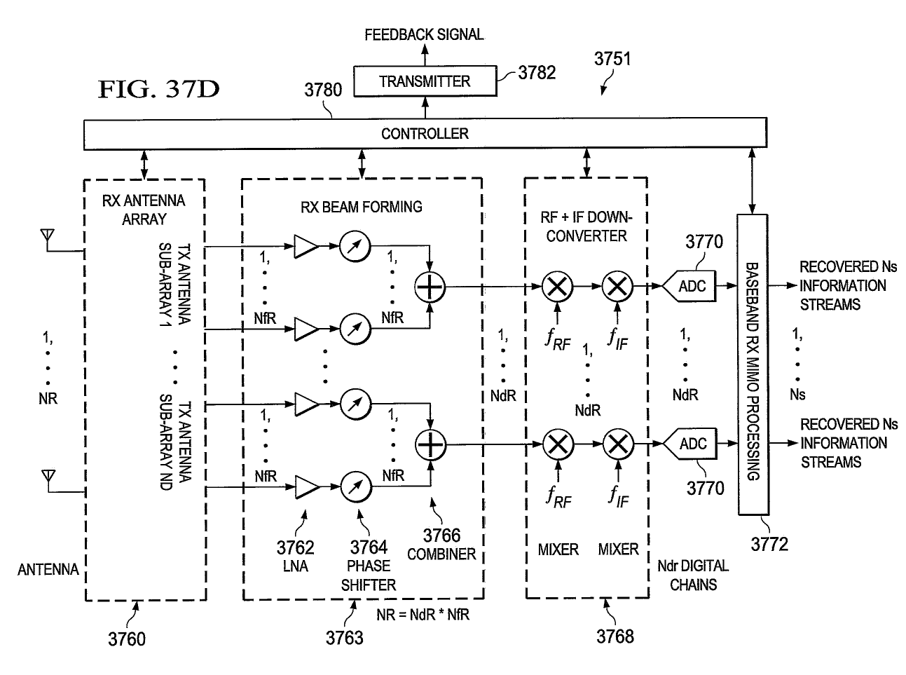

FIG. 37A illustrates a transmit path for multiple input multiple output (MIMO) baseband processing and analog beam forming with a large number of antennas, according to embodiments of this disclosure. The transmit path 3700 includes a beam forming architecture in which all of the signals output from baseband processing are fully connected to all the phase shifters and power amplifiers (PAs) of the antenna array.

As shown in FIG. 37A, Ns information streams are processed by a baseband processor (not shown), and input to the baseband TX MIMO processing block 3710. After the baseband TX MIMO processing, the information streams are converted at a digital and analog converter (DAC) 3712, and further processed by an interim frequency (IF) and radio frequency (RF) up-converter 3714, which converts the baseband signal to the signal in RF carrier band. In some embodiments, one information stream can be split to I (in-phase) and Q (quadrature) signals for modulation. After the IF and RF up-converter 3714, the signals are input to a TX beam forming module 3716.

FIG. 37A shows one possible architecture for the beam forming module 3716, where the signals are fully connected to all the phase shifters and power amplifiers (PAs) of the transmit antennas. Each of the signals from the IF and RF up-converter 3714 can go through one phase shifter 3718 and one PA 3720, and via a combiner 3722, all the signals can be combined to contribute to one of the antennas of the TX antenna array 3724. In FIG. 37A, there are Nt transmit antennas in the TX array 3724. Each antenna transmits the signal over the air. A controller 3730 can interact with the TX modules including the baseband processor, IF and RF up-converter 3714, TX beam forming module 3716, and TX antenna array module 3724. A receiver module 3732 can receive feedback signals and the feedback signals can be input to the controller 3730. The controller 3730 can process the feedback signal and adjust the TX modules.

FIG. 37B illustrates another transmit path for MIMO baseband processing and analog beam forming with a large number of antennas, according to embodiments of this disclosure. The transmit path 3701 includes a beam forming architecture in which a signal output from baseband processing is connected to the phase shifters and power amplifiers (PAs) of a sub-array of the antenna array. The transmit path 3701 is similar to the transmit path 3700 of FIG. 37A, except for differences in the beam forming module 3716.

As shown in FIG. 37B, the signal from the baseband is processed through the IF and RF up-converter 3714, and is input to the phase shifters 3718 and power amplifiers 3720 of a sub-array of the antenna array 3724, where the sub-array has Nf antennas. For the Nd signals from baseband processing (e.g., the output of the MIMO processing), if each signal goes to a sub-array with Nf antennas, the total number of transmitting antennas Nt should be Nd*Nf. The transmit path 3701 includes an equal number of antennas for each sub-array. However, the disclosure is not limited thereto. Rather, the number of antennas for each sub-array need not be equal across all sub-arrays.

FIG. 37C illustrates a receive path for MIMO baseband processing and analog beam forming with a large number of antennas, according to embodiments of this disclosure. The receive path 3750 includes a beam forming architecture in which all of the signals received at the RX antennas are processed through an amplifier (e.g., a low noise amplifier (LNA)) and a phase shifter. The signals are then combined to form an analog stream that can be further converted to the baseband signal and processed in a baseband.

As shown in FIG. 37C, NR receive antennas 3760 receive the signals transmitted by the transmit antennas over the air. The signals from the RX antennas are processed through the LNAs 3762 and the phase shifters 3764. The signals are then combined at a combiner 3766 to form an analog stream. In total, Nd analog streams can be formed. Each analog stream can be further converted to the baseband signal via a RF and IF down-converter 3768 and an analog to digital converter (ADC) 3770. The converted digital signals can be processed in a baseband RX MIMO processing module 3772 and other baseband processing, to obtain the recovered NS information streams. A controller 3780 can interact with the RX modules including baseband processor, RF and IF down-converter 3768, RX beam forming module 3763, and RX antenna array module 3760. The controller 3780 can send signals to a transmitter module 3782, which can send a feedback signal. The controller 3780 can adjust the RX modules and determine and form the feedback signal.

FIG. 37D illustrates another receive path for MIMO baseband processing and analog beam forming with a large number of antennas, according to embodiments of this disclosure. The receive path 3751 includes a beam forming architecture in which the signals received by a sub-array of the antenna array can be processed by amplifiers and phase shifters, to form an analog stream which can be converted and processed in the baseband. The receive path 3751 is similar to the receive path 3750 of FIG. 37C, except for differences in the beam forming module 3763.

As shown in FIG. 37D, the signals received by NfR antennas of a sub-array of the antenna array 3760 are processed by the LNAs 3762 and phase shifters 3764, and are combined at combiners 3766 to form an analog stream. There can be NdR sub-arrays (NdR=NR/NFR), with each sub-array forming one analog stream. Hence, in total, NdR analog streams can be formed. Each analog stream can be converted to the baseband signal via a RF and IF down-converter 3768 and an ADC 3770. The NdR digital signals are processed in the baseband module 3772 to recover the Ns information streams. The receive path 3751 includes an equal number of antennas for each sub-array. However, the disclosure is not limited thereto. Rather, the number of antennas for each sub-array need not be equal across all sub-arrays.

In other embodiments, there can be other transmit and receive paths which are similar to the paths in FIGS. 37A through 37D, but with different beam forming structures. For example, the power amplifier 3720 can be after the combiner 3722, so the number of amplifiers can be reduced. For another example, in the transmit path, there can be one or multiple output streams from the MIMO precoder inputting to a subarray of the antennas, where in the subarray the streams and the antennas are fully connected, i.e., each stream to the subarray can go to each of the antennas in the subarray. The receive path can also have a similar structure.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method comprising:
wirelessly communicating first communication traffic with a first network entity using at least one of a first beam; and
wirelessly communicating second communication traffic with a second network entity using at least one of a second beam,
wherein each of the first and second communication traffic includes at least one of backhaul traffic, wireless access traffic, and traffic for coordination in-between network entities.

2. The method of claim 1, wherein the first or second network entity comprises at least one of a hub, a base station, a base station which is connected to a hub, a base station that can relay the backhaul traffic to a hub, a first base station that can relay the backhaul traffic to a second base station, a first base station that can communicate traffic for coordination in-between base stations to coordinate with a second base station, a mobile station, a gateway, an entity in an access network or an entity as part of an access network, an entity that is connected to a core network, an entity that is part of a core network, an entity belonging to a backhaul, and the like.

3. The method of claim 1, further comprising selecting at least one path for communicating the backhaul traffic, wherein the path is formed by selecting one of the first and second network entities along the path so that the backhaul traffic can be communicated with a core network,
wherein the selecting of one of the first and second network entities according to at least one of a quality of service (QoS), a loading level of the network entity, a communication failure, an energy level of the network entity, an energy level of the base station which can relay the backhaul traffic to the core network.

4. The method of claim 1, further comprising:
powering at least one of the first and second network entities using an energy storage module; and
recharging the energy storage module using an energy generation module.

5. The method of claim 3, further comprising:
powering on the at least one network entity when at least one of a first condition is met, wherein the first condition includes at least one of:
the backhaul traffic exceeds a first specified level;
a predefined periodic time for powering on the at least one network entity arrives;
the one network entity has the energy level exceeding a first threshold;
the one network entity receives a signal for powering on its transmission;
the network entity receives a random access signal from a mobile station for powering on the transmission; and
powering off the one network entity when at least one of a second condition is met, wherein the second condition includes at least one of:
the backhaul traffic becomes less than a second specified level;
a predefined periodic time for powering off arrives;
the one network entity has the energy level lower than a second threshold;
the one network entity receives a command from the core network for powering off its transmission;
the one network entity does not have any mobile stations to serve and the one network entity has not received any random access signal for a certain amount of time.

6. The method of claim 1, further comprising:
determining whether the beams are for wireless backhaul purpose or for wireless access purpose using at least one of a predefined identification signal, a mobile station using the beams for wireless access purpose, and the network entity using the beams for wireless backhaul purpose, wherein the beams including at least one of a synchronization channel, a broadcast channel, a reference signal, and a data control channel.

7. The method of claim 6, wherein the identification signal associated with the first beam and the second beam are different relative to one another, the identification signal associated with each of the first and second beam comprising at least one of:
an explicit identifier to differentiate wireless access and wireless backhaul;
an implicit identifier indicated by partitioning a set of preambles into two sets, wherein
the identification signal is known beforehand by the mobile station and the network entities.

8. The method of claim 1, further comprising:
allocating at least one of a resource allocation for wireless backhaul traffic when at least one of a first condition is met, wherein the first condition comprises:
a wireless backhaul traffic communication request from a neighboring network entity is received;
a neighboring base station that needs wireless backhaul traffic communication is on; and
releasing the at least one resource allocation for wireless backhaul traffic when at least one of a second condition is met, wherein the second condition comprises:
no wireless backhaul traffic communication request from the neighboring network entity is received; and
the neighboring base stations that need wireless backhaul traffic communication are off,
wherein the resource allocation includes at least one of an allocation of a time resource, allocation of a frequency resource including subcarrier, and allocation of a resource in spatial domain including beams, wherein the beams can be formed by using at least one of an antenna array, and an antenna subarray.

9. The method of claim 1, further comprising:
generating the second beam using a frame structure that is similar to the frame structure used by the first beam.

10. The method of claim 1, wherein the beam is at least one of: a transmitting beam, a beam formed by at least one of a transmitter for transmitting, a receiving beam, and a beam formed by at least one of a receiver for receiving.

11. A communication network comprising:
a first network entity configured to:
wirelessly communicate first communication traffic with a second network entity using at least one of a first beam; and
wirelessly communicate second communication traffic with a third network entity using at least one of a second beam,
wherein each of the first and second communication traffic includes at least one of backhaul traffic, wireless access traffic, and traffic for coordination in-between network entities.

12. The communication network of claim 11, wherein the first, second or third network entity comprises at least one of a hub, a base station, a base station which is connected to a hub, a base station that can relay the backhaul traffic to a hub, a mobile station, a second base station that can relay the backhaul traffic to a third base station, a first base station that can communicate traffic for coordination in-between base stations to coordinate with a second base station, a mobile station, a gateway, an entity in an access network or an entity as part of an access network, an entity that is connected to a core network, an entity which is part of a core network, an entity belonging to a backhaul, and the like.

13. The communication network of claim 11, wherein the first network entity is further configured to select at least one path for communicating the backhaul traffic, wherein the path is formed by selecting one of the second and third network entities along the path so that the backhaul traffic can be communicated with the core network,
wherein the selecting of one of the second and third network entities according to at least one of a quality of service (QoS), a loading level of the network entity, a communication failure, an energy level of the network entity, an energy level of the base station which can relay the backhaul traffic to the core network.

14. The communication network of claim 11, wherein at least one of the first, second and third network entities are configured to be powered using an energy storage module, and recharge the energy storage module using an energy generation module.

15. The communication network of claim 14, wherein the at least one network entity is configured to be powered on when at least one of a first condition is met, wherein the first condition includes at least one of:
the backhaul traffic exceeds a first specified level;
a predefined periodic time for powering on the at least one network entity arrives;
the one network entity has the energy level exceeding a first threshold;
the one network entity receives a signal for powering on its transmission;
the network entity receives a random access signal from a mobile station for powering on the transmission; and
the one network entity is configured to be powered off when at least one of a second condition is met, wherein the second condition includes at least one of:
the backhaul traffic becomes less than a second specified level;
a predefined periodic time for powering off arrives;
the one network entity has the energy level lower than a second threshold;
the one network entity receives a command from the core network for powering off its transmission;
the one network entity does not have any mobile stations to serve and the one network entity has not received any random access signal for a certain amount of time.

16. The communication network of claim 11, wherein the first network entity of further configured to determine whether the beams are for wireless backhaul purpose or for wireless access purpose using at least one of a predefined identification signal, a mobile station using the beams for wireless access purpose, and the network entity using the beams for wireless backhaul purpose, wherein the beams including at least one of a synchronization channel, a broadcast channel, a reference signal, and a data control channel.

17. The communication network of claim 16, wherein the identification signal associated with the first beam and the second beam are different relative to one another, the identification signal associated with each of the first and second beam comprising at least one of:
an explicit identifier to differentiate wireless access and wireless backhaul;
an implicit identifier indicated by partitioning a set of preambles into two sets, wherein
the identification signal is known beforehand by the mobile station and the network entities.

18. The communication network of claim 11, wherein the first network entity is further configured to allocate at least one of a resource allocation for wireless backhaul traffic when at least one of a first condition is met, wherein the first condition comprises:
a wireless backhaul traffic communication request from a neighboring network entity is received;
a neighboring base station that needs wireless backhaul traffic communication is on; and
releasing the at least one resource allocation for wireless backhaul traffic when at least one of a second condition is met, wherein the second condition comprises:
no wireless backhaul traffic communication request from the neighboring network entity is received; and
the neighboring base stations that need wireless backhaul traffic communication are off, wherein the resource allocation includes at least one of an allocation of a time resource, allocation of a frequency resource including subcarrier, and allocation of a resource in spatial domain including beams, wherein the beams can be formed by using at least one of an antenna array, and an antenna subarray.

19. The communication network of claim 11, wherein the first network entity is further configured to generate the second beam using a frame structure that is similar to the frame structure used by the first beam.

20. The communication network of claim 11, wherein the beam is at least one of: a transmitting beam, a beam formed by at least one of a transmitter for transmitting, a receiving beam, and a beam formed by at least one of a receiver for receiving.
